(19) United States
(12) Patent Application Publication
(10) Pub. No.: US 2026/0015257 A1
(43) Pub. Date: Jan. 15, 2026

(54) WASTEWATER PROCESSING SYSTEMS AND METHODS

(71) Applicant: EnisWaterPure, LLC, Henderson, NV (US)

(72) Inventors: Ben ENIS, Henderson, NV (US); Ivan MIHALJEVICH, Lancaster, CA (US)

(21) Appl. No.: 18/992,908

(22) PCT Filed: Jul. 12, 2023
(86) PCT No.: PCT/US2023/070063

§ 371 Date: Jan. 9, 2025

Related U.S. Application Data
(60) Provisional application No. 63/368,333, filed on Jul. 13, 2022.

(51) Int. Cl. C02F 1/22; C02F 1/00; C02F 1/44; C02F 101/12

(52) U.S. Cl. CPC C02F 1/22; C02F 1/001; C02F 1/441; C02F 2101/12; C02F 2301/063

(57) ABSTRACT

Provided are systems and methods for wastewater processing using methods of separation by freezing. Wastewater is purified into ice by flowing a stream of gas at the eutectic temperature of the wastewater in either a counter-flow or co-flow configuration with a flowing liquid column of wastewater within an insulated chamber, forming particles of water ice from the wastewater flow.

### CROSS-REFERENCE

This application claims the benefit of U.S. Provisional Application No. 63/368,333 filed Jul. 13, 2022, which application is incorporated herein by reference.

### BACKGROUND

Provided herein are systems and methods for processing of wastewater. In some embodiments, processing of wastewater includes separation of components of the wastewater including contaminants, minerals, water, etc.

### SUMMARY

In some embodiments, provided herein are embodiments of wastewater processing system. In some embodiments, a flow of wastewater is sprayed downward as droplets into a chamber containing an updraft of super-cold gas (counter-flow) or downdraft of super cold gas (co-flow). Each spherical droplet may be frozen from the outside to inside such that a shell of freshwater ice forms and continuously extends inward against the yet to be frozen liquid spherical core. As the ice shell further thickens its inside surface may press against the outside of the incompressible liquid core. The tensile stresses in the shell build as the ice thickens. At the critical tensile fracture stress the ice shell splits into two hemispheres. The separation may cause the two hemispheres to quickly and cleanly move away from the remaining liquid core.

In some embodiments, the ice crystal formation forces any contaminant within its cage-like structure from within itself and forces the contaminant to completely transfer into the liquid core. In some embodiments, tests performed show that salt from the concentrated solutions, from seawater to 13% concentration saltwater droplets, migrate from the hemispherical shells into the liquid core. In some embodiments, delays in solidification of saturated liquid solutions are minimized by using gaseous nitrogen temperatures at −140° F. In some embodiments, droplets as large as 1.5 mm in diameter separate into hemispherical shells.

In some embodiments, provided herein is a wastewater processing system comprising: a chamber comprising: a liquid inlet comprising one or more injectors to provide wastewater into the chamber, wherein the wastewater is exits each of the one or more injectors as a liquid column and separates into wastewater droplets; one or more cold gas inlets to direct cold gas to the wastewater droplets inside the chamber, wherein the cold gas is provided at a temperature at or below a eutectic temperature of the wastewater; and a gas outlet to exhaust the cold gas from the chamber; wherein exposure of the wastewater droplets to the cold gas causes separation of water from contaminants in the wastewater droplets.

In some embodiments, the chamber is oriented vertically. In some embodiments, the liquid inlet is provided near a top portion of the chamber. In some embodiments, the gas inlet is provided at a position below the gas outlet such that a flow direction the cold gas opposes a flow direction of the wastewater. In some embodiments, the gas inlet is provided at a position below the gas outlet such that a flow direction of the cold gas is the same as a flow direction of the wastewater.

In some embodiments, the liquid inlet comprises an injector assembly. In some embodiments, the injector assembly comprises at least one circular manifold comprising the at least one injector. In some embodiments, the injector assembly comprises at least two circular manifolds. In some embodiments, the at least two manifold are arranged concentrically. In some embodiments, each manifold comprises at least two injectors. In some embodiments, the liquid inlet is configured to provide the wastewater into the chamber at a pressure of approximately 10 pounds per square inch gauge. In some embodiments, the liquid inlet is configured to produce wastewater droplets having a diameter of approximately 1.5 millimeters.

In some embodiments, the chamber further comprises a liquid outlet. In some embodiments, the gas inlet is provided at a position below the gas outlet such that a flow direction of the cold gas opposes a flow direction of the wastewater, and wherein the liquid outlet is positioned above the gas inlet. In some embodiments, the liquid outlet is configured to remove liquid contaminant separated from the water. In some embodiments, at least a portion of the water separated from the contaminants comprises solid phase ice particles, and wherein the chamber further comprises an ice particle outlet to remove the ice particles from the chamber. In some embodiments, the gas inlet is provided at a position below the gas outlet such that a flow direction of the cold gas opposes a flow direction of the wastewater, and wherein the ice particle outlet is positioned above the gas inlet.

In some embodiments, the chamber further comprises a thawing channel. In some embodiments, the thawing channel is provided below the gas inlet. In some embodiments, the thawing channel is provided below the gas outlet. In some embodiments, the thawing channel comprises one or more heaters. In some embodiments, the one or more heaters are provided against and exterior surface of the thawing channel such that heat is conducted from the one or more heaters into the thawing channel. In some embodiments, the one or more heaters are heat exchangers. In some embodiments, the heat exchangers comprise a cold side, and wherein the cold side conducts to HVAC system, cold storage system or combination thereof.

In some embodiments, the system further comprises a trommel separation system. In some embodiments, the trommel separation system is provided in the thawing channel. In some embodiments, the trommel separator system comprises a rotating trommel drum. In some embodiments, the rotating trommel drum comprises perforations. In some embodiments, the perforations are substantially circular. In some embodiments, the perforations have a diameter of approximately 1.5 millimeters. In some embodiments, the rotating trommel drum comprises a wire mesh. In some embodiments, the wire mesh comprises a plurality of square holes. In some embodiments, each square hole of the plurality of square holes comprises a side dimension of approximate 1.5 millimeters. In some embodiments, the trommel separator system further comprises a liquid catcher. In some embodiments, the liquid catcher comprises a low-friction top surface. In some embodiments, the low-friction top surface is a hydrophobic surface. In some embodiments, the low-friction top surface comprises polytetrafluoroethylene (PTFE). In some embodiments, the liquid catcher comprises a heating element.

In some embodiments, the chamber comprises perforated sidewalls. In some embodiments, the perforated sidewalls are configured as a second cold gas inlet. In some embodiments, the perforated sidewalls are configured as a heated gas inlet. In some embodiments, heated gas is sourced to the heated gas inlet from an air compressor. In some embodiments, the system further comprises a compander, wherein the air compressor supplies compressed air to an inlet of the compander. In some embodiments, the perforated sidewalls are positioned between the cold gas inlet and the cold gas outlet.

In some embodiments, the system further comprises one or more reservoirs to collect byproducts created by the exposure of the wastewater to the cold gas. In some embodiments, at least one of the one or more reservoirs is a purified water reservoir for collecting at least some of the water. In some embodiments, the chamber further comprises a purified water outlet configured to remove the water from the purified water reservoir. In some embodiments, at least one of the one or more reservoirs is a contaminated byproduct reservoir for collecting at least some of the contaminants. In some embodiments, the system further comprises a liquid contaminant outlet configured to remove a contaminated liquid byproduct containing at least some of the contaminants from the from the contaminated byproduct reservoir.

In some embodiments, the system further comprises a second chamber configured to process the contaminated liquid byproduct sourced from the contaminated byproduct reservoir. In some embodiments, the system further comprises a reverse osmosis device configured to process the contaminated liquid byproduct sourced from the contaminated byproduct reservoir. In some embodiments, the system further comprises a preliminary processing chamber, and wherein the wastewater is sourced from the preliminary processing chamber.

In some embodiments, the wastewater is sourced from a reverse osmosis device. In some embodiments, the cold gas is sourced from a compressed gas system. In some embodiments, the compressed gas system comprises a liquid nitrogen system.

In some embodiments, the system further comprises a compander, wherein the compander supplies the cold gas to the cold gas inlet.

In some embodiments, provided herein is a method for processing wastewater comprising: introducing wastewater into an insulated space; injecting a cold gas into the insulated space mixing the wastewater with the cold gas; and collecting byproducts created by the mixing of the wastewater with the cold gas.

In some embodiments, the byproducts comprise water, ice particles, or a combination thereof. In some embodiments, the method further comprising a step of segregating the byproducts. In some embodiments, the byproducts are collected in at least one byproduct reservoir. In some embodiments, the step of segregating the byproducts comprises conveying ice particles to a purified water reservoir. In some embodiments, the step of segregating the byproducts comprises collecting contaminated liquid in a contaminated byproduct reservoir.

In some embodiments, the method further comprises a step of removing the byproducts from the insulated space. In some embodiments, the method further comprises a step of processing at least one of the byproducts removed after the step of removing the byproducts from the insulated space. In some embodiments, the step of processing at least one of the byproducts comprises filtering the at least one of the byproducts by reverse osmosis.

In some embodiments, the wastewater comprises water and at least one contaminant. In some embodiments, the eutectic temperature of the wastewater is a eutectic temperature of the at least one contaminant. In some embodiments, the wastewater comprises two or more contaminants, wherein the eutectic temperature of the wastewater is the lowest eutectic temperature of the two or more contaminants.

In some embodiments, the method further comprises a step of heating a portion of the insulated space. In some embodiments, the step of heating a portion of the insulated space comprises heating an inner wall of the insulated space.

In some embodiments, the step of mixing the wastewater with the cold gas comprises flowing the cold gas in the opposite direction of a flow of the wastewater. In some embodiments, the step of mixing the wastewater with the cold gas comprises flowing the cold gas in the same direction of a flow of the wastewater.

In some embodiments, the wastewater is introduced into the insulated space via one or more injectors. In some embodiments, the wastewater is introduced into the insulated space as droplets. In some embodiments, a diameter of the droplets is approximately 1.5 millimeters or greater. In some embodiments, the insulated space is provided by a processing chamber, wherein the processing chamber comprises the chamber as disclosed by embodiments provided herein.

In some embodiments, provided herein is a wastewater processing system comprising: a first chamber comprising: a first liquid inlet to provide wastewater into the first chamber; a first cold gas inlet to direct a first cold gas to the wastewater inside the first chamber, wherein exposure of the wastewater to the first cold gas separates the wastewater into two or more byproducts, wherein the two or more byproducts comprise at least one liquid byproduct; a first gas outlet to exhaust the first cold gas from the first chamber; and a first liquid outlet to remove the at least one liquid byproduct from the first chamber; and

a second chamber comprising: a second liquid inlet to introduce the at least one liquid byproduct from the first chamber into the second chamber; a second cold gas inlet to direct a second cold gas to the at least one liquid byproduct inside the second chamber; and a second gas outlet to exhaust the second cold gas from the second chamber, wherein exposure of the at least one liquid byproduct to the second cold gas separates water or ice from contaminants of the at least one liquid byproduct.

In some embodiments, a flow direction the first cold gas opposes a flow direction of the wastewater. In some embodiments, a flow direction the second cold gas opposes a flow direction of at least one liquid byproduct. In some embodiments, a flow direction the first cold gas is the same as a flow direction of the wastewater. In some embodiments, a flow direction the second cold gas is the same as a flow direction of at least one liquid byproduct.

In some embodiments, at least one of the first liquid inlet or the second liquid inlet comprise at least one injector. In some embodiments, the at least one of the first liquid inlet or the second liquid inlet comprises an injector assembly. In some embodiments, the injector assembly comprises at least one circular manifold comprising the at least one injector. In some embodiments, the injector assembly comprises at least two circular manifolds. In some embodiments, the at least two manifold are arranged concentrically. In some embodiments, each manifold comprises at least two injectors. In some embodiments, the first liquid inlet of the first chamber comprises more injectors than the second liquid inlet of the second chamber.

In some embodiments, at least one of the first liquid inlet or the second liquid inlet is configured to provide the wastewater into the chamber at a pressure of approximately 10 pounds per square inch gauge. In some embodiments, at least one of the first liquid inlet or the second liquid inlet is configured to produce wastewater droplets having a diameter of approximately 1.5 millimeters or greater.

In some embodiments, the first chamber further comprises a first thawing channel. In some embodiments, the first thawing channel comprises one or more heaters. In some embodiments, the one or more heaters are provided against and exterior surface of the first thawing channel such that heat is conducted from the one or more heaters into the first thawing channel. In some embodiments, the one or more heaters of the first chamber are heat exchangers. In some embodiments, the heat exchangers of the first chamber comprise a cold side, and wherein the cold side conducts to a HVAC system, cold storage system or combination thereof.

In some embodiments, the second chamber further comprises a second thawing channel. In some embodiments, the second thawing channel comprises one or more heaters. In some embodiments, the one or more heaters are provided against and exterior surface of the second thawing channel such that heat is conducted from the one or more heaters into the first thawing channel. In some embodiments, the one or more heaters of the second chamber are heat exchangers. In some embodiments, the heat exchangers of the first chamber comprise a cold side, and wherein the cold side conducts to HVAC system, cold storage system or combination thereof.

In some embodiments, at least one of the first or second chambers further comprise a trommel separation system. In some embodiments, the trommel separation system is provided in the thawing channel. In some embodiments, the trommel separator system comprises a rotating trommel drum. In some embodiments, the rotating trommel drum comprises perforations. In some embodiments, the perforations are substantially circular. In some embodiments, the perforations have a diameter of approximately 1.5 millimeters. In some embodiments, the rotating trommel drum comprises a wire mesh. In some embodiments, the wire mesh comprises a plurality of square holes. In some embodiments, each square hole of the plurality of square holes comprises a side dimension of approximate 1.5 millimeters. In some embodiments, the trommel separator system further comprises a liquid catcher. In some embodiments, the liquid catcher comprises a low-friction top surface. In some embodiments, the low-friction top surface is a hydrophobic surface. In some embodiments, the low-friction top surface comprises polytetrafluoroethylene (PTFE). In some embodiments, the liquid catcher comprises a heating element.

In some embodiments, at least the first chamber comprises perforated sidewalls. In some embodiments, the perforated sidewalls are configured as a heated gas inlet. In some embodiments, the system further comprises an air compressor, wherein heated gas is sourced to the heated gas inlet from the air compressor. In some embodiments, the system further comprises a compander, wherein the air compressor supplies compressed air to an inlet of the compander. In some embodiments, the perforated sidewalls are positioned between the first cold gas inlet and the first cold gas outlet.

In some embodiments, the second cold gas is sourced from a compressed gas system. In some embodiments, the first cold gas is sourced from a compressed gas system. In some embodiments, the compressed gas system comprises a liquid nitrogen system.

In some embodiments, disclosed herein is a method for processing wastewater comprising: introducing wastewater into a first insulated space; injecting a first cold gas into the first insulated space mixing the wastewater with the first cold gas; collecting first byproducts created by the mixing of the wastewater with the first cold gas, wherein the byproducts comprise at least one liquid byproduct; removing the at least one liquid byproducts from the first insulated space; introducing the at least one liquid byproduct into a second insulated space;
injecting a second cold gas into the second insulated space; mixing the at least one liquid byproduct with the second cold gas; collecting second byproducts created by the mixing of the at least one liquid byproduct with the second cold gas.

In some embodiments, the first byproducts comprise water, ice particles, or a combination thereof. In some embodiments, the second byproducts comprise purified water, purified ice, or a combination thereof. In some embodiments, the method further comprises a step of segregating the first byproducts with the first insulated space. In some embodiments, the first byproducts are collected in at least one first byproduct reservoir.

In some embodiments, the step of segregating the first byproducts comprises conveying ice particles to a first water reservoir. In some embodiments, the step of segregating the first byproducts comprises collecting contaminated liquid in a first contaminated byproduct reservoir. In some embodiments, the wastewater comprises water and at least one first contaminant. In some embodiments, the first cold gas is injected into the first insulated space at or below a eutectic temperature of the at least one first contaminant.

In some embodiments, the wastewater comprises two or more first contaminants, wherein the first cold gas is injected at or below the lowest eutectic temperature of the two or more first contaminants. In some embodiments, the at least one liquid byproduct comprises water and at least one second contaminant.

In some embodiments, the second cold gas is injected into the second insulated space at or below a eutectic temperature of the at least one second contaminant. In some embodiments, the at least one liquid comprises two or more second contaminants, wherein the cold gas is injected at or below the lowest eutectic temperature of the two or second more contaminants.

In some embodiments, the method further comprises a step of heating a portion of the first insulated space. In some embodiments, the method further comprises a step of heating an inner of the second insulated space. In some embodiments, the step of mixing the wastewater with the first cold gas comprises flowing the first cold gas in the opposite direction of a flow of the wastewater. In some embodiments, the step of mixing the wastewater with the cold gas comprises flowing the cold gas in the same direction of a flow of the wastewater. In some embodiments, the step of mixing at least one liquid byproduct with the second cold gas comprises flowing the second cold gas in the at least one liquid byproduct. In some embodiments, the step of injecting the second cold gas into the second insulated space comprises sourcing the sourcing the second cold gas from a liquid nitrogen system.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts a wastewater processing system, according to some embodiments;

FIG. 1B depicts a wastewater processing system, according to some embodiments;

FIG. 2 depicts a wastewater processing system, according to some embodiments;

FIG. 3A shows a phase diagram for a salt solution, according to some embodiments;

FIG. 3B shows a eutectic properties for various salt solutions, according to some embodiments;

FIG. 4 depicts an exemplary operation of a wastewater processing system, according to some embodiments;

FIG. 5 depicts an exemplary operation of a wastewater processing system, according to some embodiments;

FIG. 6 depicts effects of temperature reduction on salt and mineral recovery for a brine wastewater input, according to some embodiments;

FIG. 7 shows separated hemispherical shells of freshwater ice deposited on a perforated plate; according to some embodiments;

FIG. 8A depicts requirements for a cold gas input for a wastewater processing chamber, according to some embodiments;

FIG. 8B depicts requirements for a cold gas input for a wastewater processing chamber, according to some embodiments;

FIG. 9A shows a freezing process of a spherical liquid droplet, according to some embodiments;

FIG. 9B shows a freezing process of a spherical liquid droplet, according to some embodiments;

FIG. 9C shows a freezing process of a spherical liquid droplet, according to some embodiments;

FIG. 10A depicts a compander system, according to some embodiments;

FIG. 10B depicts properties of a compander system, according to some embodiments;

FIG. 11 depicts requirements for a wastewater injection apparatus for a wastewater processing chamber, according to some embodiments;

FIG. 12 depicts properties of an air compressor of a water processing system, according to some embodiments;

FIGS. 13A-13C depict a wastewater processing system, according to some embodiments; and

FIGS. 13D-13G depict a wastewater processing system during operation, according to some embodiments.

### DETAILED DESCRIPTION

Provided herein are systems and methods for processing a wastewater solution. Processing wastewater may include purification of wastewater. Wastewater processing and/or purification may include separation of water from contaminates and/or minerals to obtain potable water. In some embodiments, the wastewater solution comprises a brine solution. In some embodiments, the brine solution is a result of industrial processes such as mining, fracking, textile production, or other industrial processes. In some embodiments, the brine solution is a mining brine solution, fracking brine solution, textile brine solution, phenolic brine solution, gold brine solution, nickel laterite brine solution, power station brine solution, or acid mine drainage treatment brine solution. In some embodiments, the brine solution comprises a concentration of salt (sodium chloride/NaCl). In some embodiments, the wastewater solution comprises one or more contaminants. In some embodiments, the one or more contaminants include salt. In some embodiments, the contaminants include calcium sulfate and/or sodium sulfate. In some embodiments, the eutectic solution is at a lower concentration (hypersaline) and both fresh water and mineral recovery are achieved.

In some embodiments, processing of a wastewater solution comprises separation of contaminants in the wastewater from the water. In some embodiments, byproducts of the processing include H₂O in a liquid (water) or solid state (ice). In some embodiments, byproducts of the processing include recovered salt, brine, minerals, or other contaminant extracted from the wastewater solution. The separation of the contaminant from the solution may occur during formation of an ice shell. The interface between the ice shell and core of liquid concentrate may clean because of the strong molecular forces that rejected any contaminant molecules that tried to interfere with the formation of the water crystal structure. Thus, high purity fresh water is achieved.

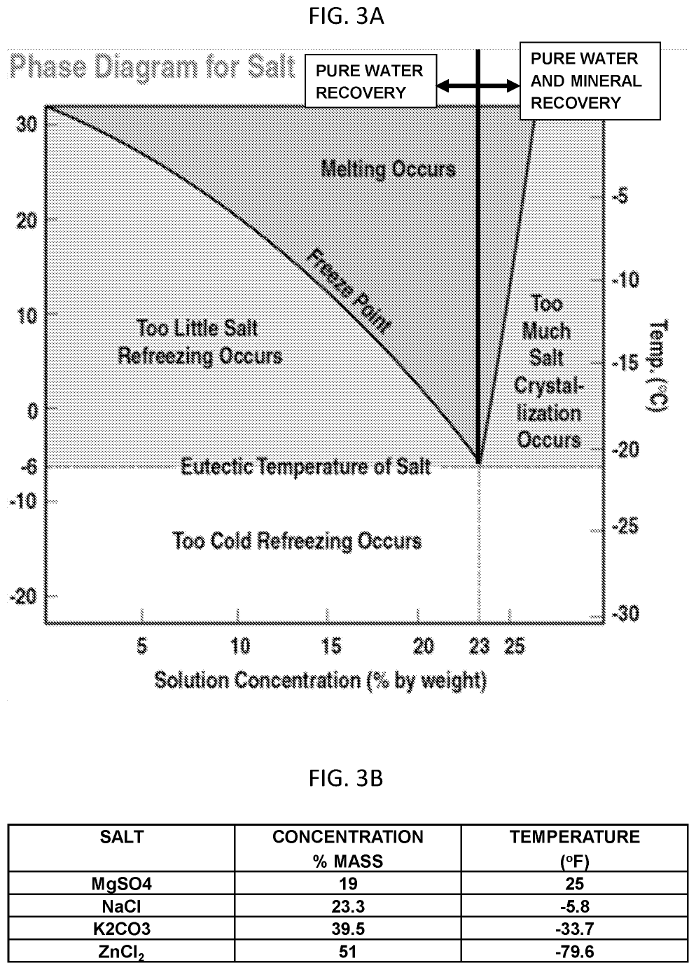

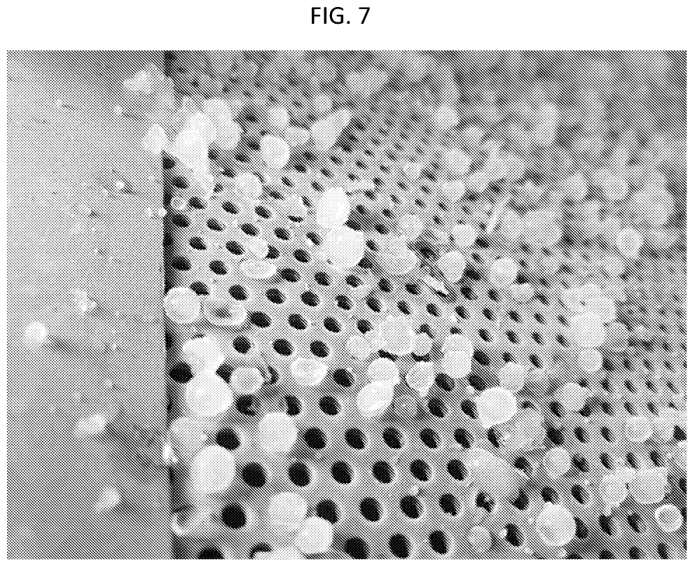

FIG. 7 depicts a phase diagram for NaCl, wherein the eutectic point may be defined by 23.3% salt concentration at the eutectic temperature of −5.8° F. In some embodiments, the eutectic concentration provides a limit to regarding freshwater recovery and mineral/contaminant recovery. Wastewater concentrations that are less than the eutectic concentration (e.g., less than 23.3% for NaCl) the recovery of fresh water may be possible. FIG. 3B shows the eutectic temperature and concentrations of various salts contaminants of wastewater streams to be processed by the systems and methods disclosed herein.

In some embodiments, wherein wastewater concentrations that are more than the eutectic concentration, the recovery of fresh water is possible using the systems and methods disclosed herein. Fresh water recover may also be possible for complex combinations of contaminants in wastewater streams using the systems and methods disclosed herein.

Waste streams with multiple contaminants may be treated. In some embodiments, the eutectic temperature comprises a primary design parameter of the freeze chamber. In some embodiments, wherein a freeze chamber is utilized to remove and collect ZnCl₂ from the waste stream, the temperature of the spray chamber gas would be provided at a lower temperature than if the freeze chamber is utilized to remove and collect NaCl. For ZnCl₂ it may be necessary to consider use of vaporized liquid nitrogen gas at −300° F. in a smaller cross-section spray Chamber or consider cold air from a Compander at −145° F. in a larger cross-section spray Chamber.

In some embodiments, utilizing super cold temperatures of the gas in the spray chamber will produce the hemispherical freshwater fragments to completely separate freshwater from the concentrated wastewater of the spherical core of liquid (which has not frozen yet). This explosive separation feature (brittle fracture of ice shell) was carefully explored in spray chamber tests. In some embodiments, the wastewater liquid core contains the eutectic concentration of each salt. There may undissolved salt crystals at the surface of each droplet deposited by the freshwater hemispherical shells as each shell explosively launched itself from the droplet. The remaining wastewater spherical core droplet contains the liquid and dissolved salt concentrations associated which provide its eutectic temperature. In some embodiments, the resultant accumulation of floating ice, liquid concentrate, and undissolved solids are separated in a thaw chamber described herein or in a commercial wash chamber.

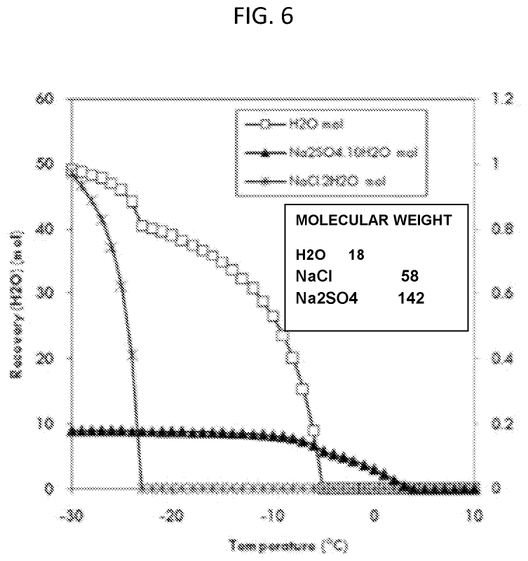

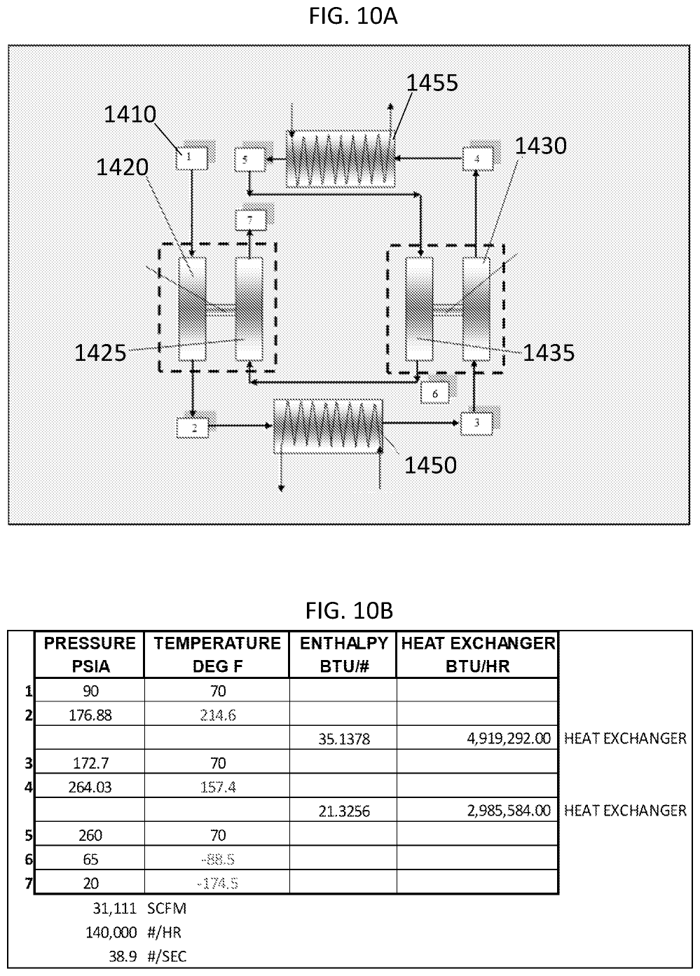

According to some embodiments, FIG. 6 shows the strong difference in molecular weights of the floating ice, concentrate liquid, and solid crystals. Even the solid crystals may have a strong atomic weight difference. Thus, differing atomic weights and melt temperatures may provide a process for recovering fresh water and minerals. FIG. 10 depicts effects of temperature reduction on salt and mineral recovery for an exemplary hypersaline solution with more than one constituents, according to some embodiments. This solution may be more complex and results in the need for more complex modeling of the phase diagram in comparison with a single constituent solution. Complex brines, such are those originating from the mining and extractive metallurgical industries may be treated using Eutectic Freeze Crystallization (EFC). EFC has been shown to be almost 100% effective in separating a single salt and water and has been applied to the complex hypersaline brines that are typical of reverse osmosis retentates. In some embodiments, coal mine wastewater is treated and commercial quantities of gypsum are recovered. Processing of a typical brine containing high levels of sodium, chlorine, sulfate, and ammonia may not be able to be achieved with other separation techniques. In some embodiments, presence of ammonia prevents the application of membrane technology (e.g., reverse osmosis) to treat the brine.

In some embodiments, FIG. 6 shows the recovery of water and the two salts as the temperature of the brine is progressively decreased. In some embodiments, wherein the solution is at a concentration less than the eutectic concentration at the eutectic temperature, the freezing of spherical droplets of wastewater, formation of spherical shells of freshwater ice around the liquid incompressible droplet provides explosive separation of freshwater ice as hemispherical shells from the remaining spherical core of concentrate. A hypersaline concentration the large diameter spherical droplets may be frozen completely during their flight through the extremely cold gas environment. In bulk freezing, the freezing of hypersaline solutions takes place at warmer temperatures than in the spray chamber, therefore so that crystallization may take up to an hour. Whereas the spray chamber provides colder temperatures on large droplets and may require less than a second of residence time. In some embodiments, at −145° F., the frozen spheres deposit at the bottom of the spray chamber and are transferred to a trommel separator where separation of crystals from mother liquor takes place progressively along the length of the trommel separator. In some embodiments, specified heat addition is applied along the trommel separator to remove specified crystals and their associated melting temperatures. This process may make use of the bulk liquid crystallizer and mechanical scraper and may deliver large diameter frozen spheres for separation of the different kinds of crystals from their mother liquor.

In some embodiments, droplet dispersion is used instead of bulk liquid freezing. In some embodiments, extremely cold gas (gas N₂ at −300° F. or air at −175° F.) is utilized instead of conventional refrigerants. This may allow for the removal of a wider range of contaminants that have extremely low eutectic temperatures (NaCl is at −5.8° F.). The use of a monodisperse cloud of same-diameter spherical droplets in the super-chilled gas may permit rapid chilling of each droplet from the outside to the inside core. When the ice shell forms the contaminants are rejected, creating a frozen freshwater shell. In some embodiments, ice shell grows around an incompressible liquid so that tensile stresses set in and keep increasing the brittle ice shell explosively breaks into two hemispheres and separates into the neighboring cold gas at high velocity. Thus, there may mechanism for separating fresh water from wastewater. The extremely cold gas compared to the wastewater droplet may overcome issues of time delays in the formation of the shell. The overall freezing and separation process may require less than a second or two, so the height of the spray chamber may be reduced. In some embodiments, a smaller chamber cross-section may be utilized because the gas used is so cold and dense.

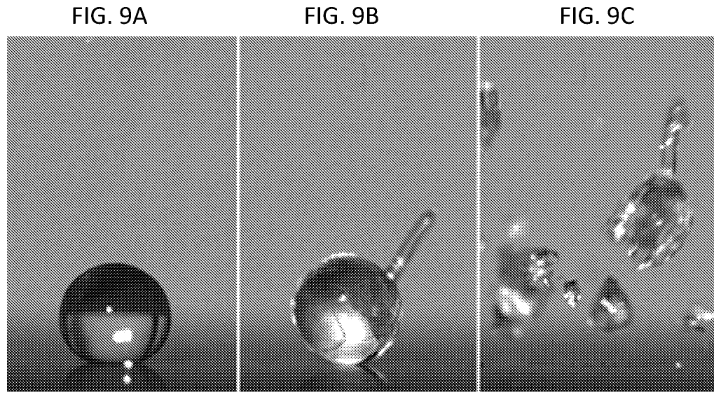

FIGS. 9A-9C show freezing of a liquid droplet captured by a high-speed video camera. According to some embodiments, the freezing process of a 2.8 mm diameter pulp mill effluent drop in an ambient air temperature of −5.5° C. and 80.1% humidity begins 1/30 second after exposure, as shown in FIG. 9A. The freezing starts at the bottom edge of the droplet and proceeded to the entire surface of the droplet, as shown in FIG. 9B. The droplet surface freezing is complete in 7/30 second. As the ice shell thickens its inside surface may press against the outside of the incompressible liquid core. The tensile stresses in the shell build as the ice thickens. At the critical tensile fracture stress the ice shell fractures and explosively separates as shown in FIG. 9C.

Explosive separations may allow for further processing of saltwater droplets as respective cores of each of the remaining high-concentration salt spheres using large (1 mm or greater) diameter droplets, an atmospheric pressure environment, without the need for silver iodide to initiate phase change. Processing of 13% saltwater solutions may be possible, which is not achievable by reverse osmosis. Under conditions as described herein, the freezing and explosive separation of the shells, as well as the mass transfer of salt, may take place in less than 1 second. The crystal formation of ice is powerful and fast allowing a wide range of wastewater contaminants to become amenable to capture and remove.

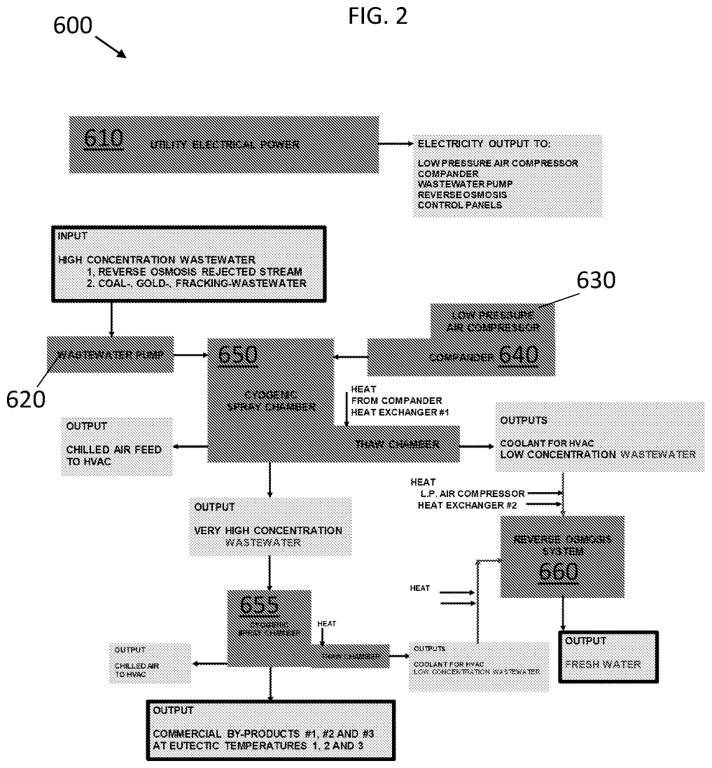

In some embodiments, as depicted by FIG. 2, a processing chamber 650 may comprise a portion of a wastewater processing system 600. In some embodiments, an electricity source 610 is used to power components of the system 600. In some embodiments, the electrical source 610 is a utility power source. In some embodiments, alternative electrical sources are used such as solar power, wind turbine energy, generator systems, or other suitable electrical sources. The electrical source may be used to power components of the processing system such as the air compressor 630, compander 640, wastewater pump 620, reverse osmosis system 660, and any further electrical controls, components, or devices utilized in the system 600.

In some embodiments, a wastewater pump 620 wastewater source is used to inject wastewater into a freeze chamber 650. In some embodiments, the wastewater undergoes a filtering process to remove solid particles prior to being pumped.

In some embodiments, an air compressor 630 injects compressed air into an input of a compander system. In some embodiments, a cold air output from the compander system is injected into a freeze chamber 650 and utilized as a cold air source for a freeze process. In some embodiments, the air compressor and compander system are replaced by a liquefied gas source, as further described herein.

In some embodiments, excess cold air from exit ducts of a freeze chamber 650 is output to an HVAC system. In some embodiments, excess cold air from exit ducts of a freeze chamber 650 is output to an intake of a power generator set (e.g., gas turbine generator set) to improve efficiency of the generator set. In some embodiments, the excess cold air from exit ducts of a freeze chamber 650 is output to a cold storage system. In some embodiments, waste heat from the compander system 640 is utilized to provide heat to a thawing channel of the freeze chamber 650.

In some embodiments, the freeze chamber 650 is configured to separate byproducts of the wastewater processing. In some embodiments, the freeze chamber 650 segregates byproducts by eutectic temperatures. In some embodiments, a byproduct having a high concentration of contaminants is output to a second freeze chamber 655. The second freeze chamber may be substantially similar to a first or primary freeze chamber 650. In some embodiments, the second freeze chamber 655 is smaller than the primary freeze chamber 650. In some embodiments, excess cold air from exit ducts of a second freeze chamber 655 is output to an HVAC system. In some embodiments, waste heat from the compander system 640 is utilized to provide heat to a thawing channel of the second freeze chamber 655. In some embodiments, the second freeze chamber 655 recovers byproducts having commercial use. In some embodiments, the second freeze chamber 655 segregates byproducts by eutectic temperatures.

In some embodiments, freeze chamber 650 outputs byproducts having a low concentration of contaminants to a reverse osmosis system 660. In some embodiments, secondary freeze chamber 655 outputs byproducts having a low concentration of contaminants to a reverse osmosis system 660. In some embodiments, the reverse osmosis system 660 outputs fresh water.

### I. WASTEWATER PROCESSING CHAMBER

In some embodiments, systems and methods of wastewater processing include use of a wastewater processing chamber. The wastewater processing chamber may be referred to as an insulated chamber, freeze chamber, purification chamber, processing chamber, eutectic freeze chamber, spray chamber, or simply a chamber herein.

In some embodiments, the chamber provides conditions for separation of water from contaminants of wastewater by injecting wastewater droplets into a cold air stream. In some embodiments, the cold air stream is provided at a temperature at or below the eutectic or triple point temperature of the wastewater. In some embodiments, the eutectic or triple point temperature of the wastewater is taken as the lowest eutectic temperature of the components, constituent, or contaminants in the wastewater. For example, in wastewater comprising sodium chloride (NaCl) and zinc chloride (ZnCl₂), the cold air stream will be provided at or below the eutectic temperature of the zinc chloride, as the zinc chloride has a lower eutectic temperature than the sodium chloride. In the example, ZnCl₂ may have a eutectic temperature of about −79.6 degrees Fahrenheit (° F.). Therefore, according to some embodiments, the cold air flow should be provided at a temperature at or below about −79.6° F.

Providing cold air at a temperature at or below the eutectic temperature of the wastewater may allow formation of a spherical ice shell around a spherical liquid waste droplet. In some embodiments, the ice shell thickens as the cold front moves from the outside to the inside of the droplet. In some embodiments, ice shell thickens until it fractures into two hemispherical brittle shells. In some embodiments, fracturing of the ice shell causes the particles of the fractured ice shell to project radially outward from the droplet. The radial projection of ice shell fragments may be referred to as explosive separation of the pure or nearly pure ice fragments from a concentrated wastewater core. The wastewater processing chambers disclosed herein may be configured to produce explosive separation of ice fragments from wastewater droplets.

In some embodiments, the processing chamber is configured as a counter-flow or updraft chamber, wherein droplets of wastewater are sprayed downward and the cold gas flows upward. In some embodiments, this configuration includes one or more cold air inlets or intakes positioned below one or more cold air outlets or exhausts to produce a cold air stream flowing in an upward direction, counter to the acceleration of gravity. In some embodiments, the processing chamber includes a wastewater inlet positioned above the cold air inlet, such that the wastewater flows in the direction of gravity and is introduced into a cold air stream flowing in the opposite direction, such that the cold air stream opposes the wastewater stream.

In some embodiments, the processing chamber is configured as a co-flow or downdraft chamber, wherein droplets of wastewater are sprayed downward and the cold gas also flows downward. In some embodiments, this configuration includes one or more cold air inlets or intakes positioned above one or more cold air outlets or exhausts to produce a cold air stream flowing in a downward direction, with the acceleration of gravity. In some embodiments, the processing chamber includes a wastewater inlet positioned above the cold air inlet, such that the wastewater flows in the direction of gravity and is introduced into a cold air stream flowing in the same direction, such that the cold air stream flows with the wastewater stream.

The co-flow and counter flow chamber configurations are further described herein. The co-flow or counter-flow freeze chamber configurations may be used to recover freshwater from a wastewater having a lower contaminant concentration than the eutectic concentration point. In some embodiments, a counter-flow chamber is utilized to recover freshwater from a wastewater concentration having a higher contaminant concentration than the eutectic concentration point. Example eutectic concentrations points may be depicted by FIG. 3B.

In some embodiments, the chamber has a fixed cross-section size along its entire height. The two phase fluid at the gas injection height may be colder at the bottom than at the top. The bottom zone of the chamber may flow the same quantity or mass volume of cold air as the top zone. The upward velocity of the cold air flow at the bottom of the chamber may be slower than at the top of the chamber.

In some embodiments, the freeze chamber comprises a wastewater inlet apparatus. In some embodiments, the wastewater inlet apparatus comprises one or more elongated cylindrical members or injectors for injection wastewater into the chamber.

In some embodiments, the chamber comprises one or more cold gas inlets. In some embodiments, the chamber comprises four gas inlets. In some embodiments, wherein the cross-section of the chamber is rectangular or square, at least one cold gas inlet is provided on each sidewall. In some embodiments, wherein the cross-section of the chamber is substantial circular, one or more inlets may be provided about the circumference of the chamber. The cold air may be sourced from various systems. Example sources of cold gas flow further described herein may include a compressed and liquefied gas system and/or a compander system.

In some embodiments, the chamber comprises one or more gas outlets to exhaust cold air from the chamber. In some embodiments, the chamber comprises four gas outlets. In some embodiments, wherein the cross-section of the chamber is rectangular or square, at least one cold gas inlet is provided on each sidewall. In some embodiments, wherein the cross-section of the chamber is substantial circular, one or more inlets may be provided about the circumference of the chamber. In some embodiments, the gas exiting the chamber may be utilized in a heating, ventilation, and air conditioning system (HVAC).

In some embodiments, the chamber is configured as a counter-flow chamber, as. The gas outlets or exhaust ducts may be positioned above the gas inlets, such that the cold air flow is directed toward the top of the chamber and opposing the flow of wastewater droplets as the droplets fall toward the bottom of the chamber.

In some embodiments, a byproduct reservoir is provided at the bottom of the chamber to collect the contaminated byproducts from the wastewater processing. In some embodiments, portions of the ice transfer tunnel and spray chamber are enveloped such that the cryogenic gases escape solely through the exit ducts. Thus, all fresh water and concentrated wastewater may be extracted through liquid filled pipes to assure a seal.

In some embodiments, a trommel separation system further comprises further comprises a slide. The slide may collect ice particles and direct them towards the trommel separator. In some embodiments, the slide is perforated such that liquid byproducts pass through the slide and into the byproduct reservoir. In some embodiments, the slide comprises a solid surface, such that both liquid byproducts and the ice particles enter the trommel separator.

In some embodiments, the distance between the injected liquid column and the cold air flow between the outlet and inlet allows for the liquid column to breakup and spherical droplet to form at the top of the chamber before the droplets enter the flowing chilled gas stream. In some embodiments, turbulent flow causes transverse displacement of the freezing droplet on its downward trajectory. In some embodiments, vertical injecting of uniform size large droplets at high velocity is used to avoid impact on the inside surfaces of the walls of the chamber.

In some embodiments, trommel separator is perforated such that the holes are sufficiently small to capture the uniform large-sized hemispherical shells and even sufficiently large to pass the smaller diameter spherical cores through to the bottom (as depicted in FIG. 7). In some embodiments, the perforations in the separator are approximately equal to the inner diameter of the injectors. This configuration may be practical because of the difficulty in achieving the ideal match of aerodynamic requirements to achieve a configuration wherein ice shells fly up and dense liquid spheres, containing contaminants, continue their downward flight. In some embodiments, the sieve characteristic of the trommel separator is used to separate the freshwater ice shells from the frozen concentrate core spheres.

In some embodiments, the separated fragments fall into a collection vat at the bottom of the chamber below a dead air volume zone. In some embodiments, heat is conducted within the bottom of the chamber to warm the frozen contents to eutectic temperature. In some embodiments, a heated collection vat maintains the fresh water as low density ice but liquefies the frozen concentrate ice spheres. In some embodiments, the freshwater ice is continuously removed and stored separately, while the liquid concentrate and solid crystals are drained from the bottom of the collection vat. Washing may remove any contaminants that were attracted to the interface between the ice and concentrate liquid.

### A. Counter Flow Parameters

In some embodiments, the chamber is configured as a counter-flow chamber. The gas outlets or exhaust ducts may be positioned above the gas inlets, such that the cold air flow is directed toward the top of the chamber and opposing the flow of wastewater droplets as the droplets fall toward the bottom of the chamber. In some embodiments, a counter-flow the chamber is configured such that freshwater ice hemispheres are formed, separated from the spherical cores of liquid concentrate, and are dragged upward and out of the chamber. In some embodiments, the ice hemispheres exit through outlets. In some embodiments, the remaining spherical core of dense concentrate will continue downward for capture of the concentrate. Therefore, the need for the trommel separation system may be optional. In some embodiments the system further comprises one or more heating elements. This scenario may produce the purest fresh water because the separation is accomplished at the crystal cage formation where contaminants are forced from within the cage of frozen water molecules. Heating elements may be provided in thermal communication with the transfer tunnel.

In some embodiments, a mismatch of aerodynamic characteristics results in particles moving downward through the cold updraft into and through the dead air zone and into a collection vat located below the dead air zone at the bottom of the chamber. In some embodiments, there is no trommel separator and all particles fall into a collection vat that is heated to the eutectic condition where the freshwater ice fragments float on the dense liquid concentrate.

In some embodiments, the trommel separator at the bottom of the dead volume transfers all depositing particles of hemispherical ice shells. In some embodiments, the perforated hole sizes are configured to capture the larger size ice shells and to allow the smaller frozen spheres to continue downward.

### II. WASTEWATER INJECTION PIPING ARRAY

For production of spherical droplets having a sufficient diameter to induce explosive separation of wastewater droplets, it may be necessary to provide an injection apparatus which configured to form a plurality of droplets of a sufficient diameter and nearly spherical in shape.

In an embodiment, pressurized wastewater is passed through one or more elongated cylinders or tubes, which may be referred to herein as injectors. In some embodiments, the injectors are configured to form an injected stream of wastewater. Near an exit or outlet of each injector, the wastewater may form a flowing column of liquid. In some embodiments, the column of liquid oscillates breaks up into fragments and forms separated spheres as the injected fluid reaches further downstream into the chamber. This mechanism may provide a particular advantage over a spray nozzle, as the injectors may produce the required spherical droplet size for efficient explosive separation within the chamber, whereas smaller droplets from a spray nozzle may migrate toward the wall of the chamber.

The droplet size may increase the amount of wastewater flow that can be treated in the chamber considering the spacing between droplets to avoid droplets impacting and coalescing. The droplet sizes may also produce other advantages downstream. In some embodiments, the droplets, when frozen produce hemispherical shells and associated liquid cores that facilitate aerodynamic and/or mechanical separate.

In some embodiments, the water injection apparatus or component of the wastewater processing chamber comprises an injector array. The water injection apparatus may comprise one or more injectors to provide a column of liquid wastewater which will break into a plurality of spherical wastewater droplets.

In some embodiments, a plurality of injectors may be provided. Each injector may extend from a manifold providing the wastewater to the injectors. In some embodiments, more than one manifold is provided. The manifolds may be circular. A plurality of circular manifolds may be arranged concentrically. In some embodiments, manifolds may be elliptical, rectangular, or of another suitable design.

In some embodiments, the wastewater injection manifolds are supported by an injector plate. The manifolds may be secured to the injector plate by welding, support brackets, or other suitable means.

In some embodiments, small scale configurations may be desirable. In some embodiments a wastewater injection component may comprise a single injector. In a single injector embodiment, it may be possible to process 100 gallons of wastewater. A small configuration may be desirable for in-home application and/or as a unit for secondary processing.

In some embodiments, wastewater injection component comprises 1 injector to 500 injectors. In some embodiments, wastewater injection component comprises 1 injector to 18 injectors, 1 injector to 28 injectors, 1 injector to 50 injectors, 1 injector to 110 injectors, 1 injector to 150 injectors, 1 injector to 200 injectors, 1 injector to 300 injectors, 1 injector to 350 injectors, 1 injector to 400 injectors, 1 injector to 440 injectors, 1 injector to 500 injectors, 18 injectors to 28 injectors, 18 injectors to 50 injectors, 18 injectors to 110 injectors, 18 injectors to 150 injectors, 18 injectors to 200 injectors, 18 injectors to 300 injectors, 18 injectors to 350 injectors, 18 injectors to 400 injectors, 18 injectors to 440 injectors, 18 injectors to 500 injectors, 28 injectors to 50 injectors, 28 injectors to 110 injectors, 28 injectors to 150 injectors, 28 injectors to 200 injectors, 28 injectors to 300 injectors, 28 injectors to 350 injectors, 28 injectors to 400 injectors, 28 injectors to 440 injectors, 28 injectors to 500 injectors, 50 injectors to 110 injectors, 50 injectors to 150 injectors, 50 injectors to 200 injectors, 50 injectors to 300 injectors, 50 injectors to 350 injectors, 50 injectors to 400 injectors, 50 injectors to 440 injectors, 50 injectors to 500 injectors, 110 injectors to 150 injectors, 110 injectors to 200 injectors, 110 injectors to 300 injectors, 110 injectors to 350 injectors, 110 injectors to 400 injectors, 110 injectors to 440 injectors, 110 injectors to 500 injectors, 150 injectors to 200 injectors, 150 injectors to 300 injectors, 150 injectors to 350 injectors, 150 injectors to 400 injectors, 150 injectors to 440 injectors, 150 injectors to 500 injectors, 200 injectors to 300 injectors, 200 injectors to 350 injectors, 200 injectors to 400 injectors, 200 injectors to 440 injectors, 200 injectors to 500 injectors, 300 injectors to 350 injectors, 300 injectors to 400 injectors, 300 injectors to 440 injectors, 300 injectors to 500 injectors, 350 injectors to 400 injectors, 350 injectors to 440 injectors, 350 injectors to 500 injectors, 400 injectors to 440 injectors, 400 injectors to 500 injectors, or 440 injectors to 500 injectors. In some embodiments, wastewater injection component comprises 1 injector, 18 injectors, 28 injectors, 50 injectors, 110 injectors, 150 injectors, 200 injectors, 300 injectors, 350 injectors, 400 injectors, 440 injectors, or 500 injectors. In some embodiments, wastewater injection component comprises at least 1 injector, 18 injectors, 28 injectors, 50 injectors, 110 injectors, 150 injectors, 200 injectors, 300 injectors, 350 injectors, 400 injectors, or 440 injectors. In some embodiments, wastewater injection component comprises at most 18 injectors, 28 injectors, 50 injectors, 110 injectors, 150 injectors, 200 injectors, 300 injectors, 350 injectors, 400 injectors, 440 injectors, or 500 injectors.

In some embodiments, the wastewater injection apparatus is configured to produce spherical wastewater droplets having a diameter of approximately 1.5 millimeters (mm). In some embodiments, each injector comprises an inner diameter approximately equal to the diameter of the spherical wastewater droplet to be formed. In some embodiments, the inner diameter of each injector is approximately 1.5 mm. In some embodiments, the inner diameter of each injector is about 0.5 mm to about 2.5 mm. In some embodiments, the inner diameter of each injector is about 0.5 mm to about 0.75 mm, about 0.5 mm to about 1 mm, about 0.5 mm to about 1.25 mm, about 0.5 mm to about 1.5 mm, about 0.5 mm to about 1.75 mm, about 0.5 mm to about 2 mm, about 0.5 mm to about 2.25 mm, about 0.5 mm to about 2.5 mm, about 0.75 mm to about 1 mm, about 0.75 mm to about 1.25 mm, about 0.75 mm to about 1.5 mm, about 0.75 mm to about 1.75 mm, about 0.75 mm to about 2 mm, about 0.75 mm to about 2.25 mm, about 0.75 mm to about 2.5 mm, about 1 mm to about 1.25 mm, about 1 mm to about 1.5 mm, about 1 mm to about 1.75 mm, about 1 mm to about 2 mm, about 1 mm to about 2.25 mm, about 1 mm to about 2.5 mm, about 1.25 mm to about 1.5 mm, about 1.25 mm to about 1.75 mm, about 1.25 mm to about 2 mm, about 1.25 mm to about 2.25 mm, about 1.25 mm to about 2.5 mm, about 1.5 mm to about 1.75 mm, about 1.5 mm to about 2 mm, about 1.5 mm to about 2.25 mm, about 1.5 mm to about 2.5 mm, about 1.75 mm to about 2 mm, about 1.75 mm to about 2.25 mm, about 1.75 mm to about 2.5 mm, about 2 mm to about 2.25 mm, about 2 mm to about 2.5 mm, or about 2.25 mm to about 2.5 mm. In some embodiments, the inner diameter of each injector is about 0.5 mm, about 0.75 mm, about 1 mm, about 1.25 mm, about 1.5 mm, about 1.75 mm, about 2 mm, about 2.25 mm, or about 2.5 mm. In some embodiments, the inner diameter of each injector is at least about 0.5 mm, about 0.75 mm, about 1 mm, about 1.25 mm, about 1.5 mm, about 1.75 mm, about 2 mm, or about 2.25 mm. In some embodiments, the inner diameter of each injector is at most about 0.75 mm, about 1 mm, about 1.25 mm, about 1.5 mm, about 1.75 mm, about 2 mm, about 2.25 mm, or about 2.5 mm.

In some embodiments, the wastewater is pressurized through the injectors at approximately 12 pounds per square inch gauge (psig). In some embodiments, the psig measurement is relative to the pressure inside of the chamber. In some embodiments, the wastewater is pressurized through the injectors at 5 psig to 30 psig. In some embodiments, the wastewater is pressurized through the injectors at 5 psig to 10 psig, 5 psig to 12 psig, 5 psig to 15 psig, 5 psig to 17 psig, 5 psig to 20 psig, 5 psig to 25 psig, 5 psig to 30 psig, 10 psig to 12 psig, 10 psig to 15 psig, 10 psig to 17 psig, 10 psig to 20 psig, 10 psig to 25 psig, 10 psig to 30 psig, 12 psig to 15 psig, 12 psig to 17 psig, 12 psig to 20 psig, 12 psig to 25 psig, 12 psig to 30 psig, 15 psig to 17 psig, 15 psig to 20 psig, 15 psig to 25 psig, 15 psig to 30 psig, 17 psig to 20 psig, 17 psig to 25 psig, 17 psig to 30 psig, 20 psig to 25 psig, 20 psig to 30 psig, or 25 psig to 30 psig. In some embodiments, the wastewater is pressurized through the injectors at 5 psig, 10 psig, 12 psig, 15 psig, 17 psig, 20 psig, 25 psig, or 30 psig. In some embodiments, the wastewater is pressurized through the injectors at least at 5 psig, 10 psig, 12 psig, 15 psig, 17 psig, 20 psig, or 25 psig. In some embodiments, the wastewater is pressurized through the injectors at 10 psig, 12 psig, 15 psig, 17 psig, 20 psig, 25 psig, or 30 psig at most.

In some embodiments, the length of each injector is at least 4 times the inner diameter of said injector. In some embodiments, the ratio of the length to the inner diameter of each injector is about 2:1 to about 20:1. In some embodiments, the ratio of the length to the inner diameter of each injector is about 2:1 to about 3:1, about 2:1 to about 4:1, about 2:1 to about 5:1, about 2:1 to about 6:1, about 2:1 to about 8:1, about 2:1 to about 10:1, about 2:1 to about 15:1, about 2:1 to about 20:1, about 3:1 to about 4:1, about 3:1 to about 5:1, about 3:1 to about 6:1, about 3:1 to about 8:1, about 3:1 to about 10:1, about 3:1 to about 15:1, about 3:1 to about 20:1, about 4:1 to about 5:1, about 4:1 to about 6:1, about 4:1 to about 8:1, about 4:1 to about 10:1, about 4:1 to about 15:1, about 4:1 to about 20:1, about 5:1 to about 6:1, about 5:1 to about 8:1, about 5:1 to about 10:1, about 5:1 to about 15:1, about 5:1 to about 20:1, about 6:1 to about 8:1, about 6:1 to about 10:1, about 6:1 to about 15:1, about 6:1 to about 20:1, about 8:1 to about 10:1, about 8:1 to about 15:1, about 8:1 to about 20:1, about 10:1 to about 15:1, about 10:1 to about 20:1, or about 15:1 to about 20:1. In some embodiments, the ratio of the length to the inner diameter of each injector is about 2:1, about 3:1, about 4:1, about 5:1, about 6:1, about 8:1, about 10:1, about 15:1, or about 20:1. In some embodiments, the ratio of the length to the inner diameter of each injector is at least about 2:1, about 3:1, about 4:1, about 5:1, about 6:1, about 8:1, about 10:1, or about 15:1. In some embodiments, the ratio of the length to the inner diameter of each injector is at most about 3:1, about 4:1, about 5:1, about 6:1, about 8:1, about 10:1, about 15:1, or about 20:1.

In some embodiments, the wastewater is precooled prior to being injected into the chamber. In some embodiments, the wastewater is cooled via a heat exchanger that applied to both the wastewater stream and a portion of the cold gas stream. In some embodiments, the wastewater is cooled to near its freezing point. For example, for NaCl, the wastewater may be precooled to approximately +40° F. Cooling of the wastewater may reduce the required residence time to freeze the droplets, thereby reducing the required height of the chamber. Wastewater may also increase the viscosity of the wastewater, decreasing the chance of the wastewater droplets dispersing into smaller diameter droplets than desired.

In some embodiments, prior to injection into the chamber the wastewater is cooled to 30° F. to 60° F. In some embodiments, prior to injection into the chamber the wastewater is cooled to 60° F. to 55° F., 60° F. to 50° F., 60° F. to 45° F., 60° F. to 40° F., 60° F. to 35° F., 60° F. to 30° F., 55° F. to 50° F., 55° F. to 45° F., 55° F. to 40° F., 55° F. to 35° F., 55° F. to 30° F., 50° F. to 45° F., 50° F. to 40° F., 50° F. to 35° F., 50° F. to 30° F., 45° F. to 40° F., 45° F. to 35° F., 45° F. to 30° F., 40° F. to 35° F., 40° F. to 30° F., or 35° F. to 30° F. In some embodiments, prior to injection into the chamber the wastewater is cooled to 60° F., 55° F., 50° F., 45° F., 40° F., 35° F., or 30° F. In some embodiments, prior to injection into the chamber the wastewater is cooled to at least 60° F., 55° F., 50° F., 45° F., 40° F., or 35° F. In some embodiments, prior to injection into the chamber the wastewater is cooled to at most 55° F., 50° F., 45° F., 40° F., 35° F., or 30° F.

### III. THAWING CHAMBER

In some embodiments, a bottom portion of the freeze chamber is configured as an ice transfer tunnel or thawing chamber. In some embodiments, the ice transfer tunnel is configured as a thawing chamber. In some embodiments, the thawing chamber is positioned at the bottom of the chamber. In some embodiments, the thawing chamber is positioned within a dead air volume of the chamber, wherein relatively little or no air flow takes place. Sufficient height of the dead gas zone at the bottom of the chamber may be required to prevent cold injection gas flow from entering into it in significant quantity. In some embodiments, the hemispherical shells of frozen freshwater ice and the spherical cores of frozen concentrate, having passed through a zone of extremely cold air, are brought to a temperature slightly colder than the eutectic temperature.

In some embodiments, a thawing chamber comprises one or more heaters. In some embodiments, the heaters are provided as heat exchangers and cold air from the chamber may be sourced to another component of the system as disclosed herein. In some embodiments, the temperature of the thawing chamber is held such that the fresh frozen water ice shells are warmed, but remain as ice, and the concentrate is liquefied such that the ice floats atop the liquefied contaminant solution.

In some embodiments, the temperature within the thawing chamber is held at approximately −10° F. In some embodiments, the temperature within the thawing chamber is about −100° F. to about −10° F. In some embodiments, the temperature within the thawing chamber is about −100° F. to about −90° F., about −100° F. to about −70° F., about −100° F. to about −80° F., about −100° F. to about −60° F., about −100° F. to about −50° F., about −100° F. to about −40° F., about −100° F. to about −30° F., about −100° F. to about −20° F., about −100° F. to about −10° F., about −90° F. to about −70° F., about −90° F. to about −80° F., about −90° F. to about −60° F., about −90° F. to about −50° F., about −90° F. to about −40° F., about −90° F. to about −30° F., about −90° F. to about −20° F., about −90° F. to about −10° F., about −70° F. to about −80° F., about −70° F. to about −60° F., about −70° F. to about −50° F., about −70° F. to about −40° F., about −70° F. to about −30° F., about −70° F. to about −20° F., about −70° F. to about −10° F., about −80° F. to about −60° F., about −80° F. to about −50° F., about −80° F. to about −40° F., about −80° F. to about −30° F., about −80° F. to about −20° F., about −80° F. to about −10° F., about −60° F. to about −50° F., about −60° F. to about −40° F., about −60° F. to about −30° F., about −60° F. to about −20° F., about −60° F. to about −10° F., about −50° F. to about −40° F., about −50° F. to about −30° F., about −50° F. to about −20° F., about −50° F. to about −10° F., about −40° F. to about −30° F., about −40° F. to about −20° F., about −40° F. to about −10° F., about −30° F. to about −20° F., about −30° F. to about −10° F., or about −20° F. to about −10° F. In some embodiments, the temperature within the thawing chamber is about −100° F., about −90° F., about −70° F., about −80° F., about −60° F., about −50° F., about −40° F., about −30° F., about −20° F., or about −10° F. In some embodiments, the temperature within the thawing chamber is at least about −100° F., about −90° F., about −70° F., about −80° F., about −60° F., about −50° F., about −40° F., about −30° F., or about −20° F. In some embodiments, the temperature within the thawing chamber is at most about −90° F., about −70° F., about −80° F., about −60° F., about −50° F., about −40° F., about −30° F., about −20° F., or about −10° F.

In some embodiments, a one or more temperature sensors may be used to monitor one or more locations within the thawing chamber. In some embodiments, the heat output of heaters may be controlled to hold the thawing chamber at a desired temperature. In some embodiments, the thawing tunnel is configured to deliver a series of specific warmer and warmer temperatures. In some embodiments, a series of warmer temperatures permits segregated recovery of contaminants that have specific eutectic temperatures.

In some embodiments, the downstream thawing tunnel will have a first heater deliver the heat transfer over the available initial length of the tunnel to recover the crystals of a contaminant with the lowest eutectic temperature. The recovered minerals may be collected in a first collection vat. In some embodiments, a second heater delivers heat over its length of the tunnel to recover the crystals of a higher eutectic temperature. The recovered minerals may be collected in a second collection vat. In some embodiments, a third or final heater delivers heat to produce liquid water. The recovered minerals may be collected in a third or final collection vat.

In an example embodiment, a wastewater solution may comprise water, K₂CO₃, and NaCl. The first heater may deliver heat to an initial length of the thawing chamber to recover K₂CO₃ in the first collection vat. The second heater may deliver heat to an initial length of the thawing chamber to recover NaCl in the second collection vat. The third heater may deliver heat to an initial length of the thawing chamber to recover water in the third collection vat.

In some embodiments, the thaw channel is completely encased. Thus, the liquids may be drained from vats that have ullage volumes and the solid crystals in their vats will be removed with some loss of chilled gas from the bottom of the spray chamber.

In some embodiments, the heaters are heat exchangers. In some embodiments, heat supplied to the heat exchangers on the thawing tunnel is sourced from a compressor's waste heat release and/or the compander's waste heat release. In some embodiments, heat supplied to the heat exchangers on the thawing tunnel is sourced from an ambient temperature water that is chilled for use elsewhere.

### A. Trommel Separation System

In some embodiments, a trommel separation system is provided to separate frozen ice shells from liquid wastewater concentrate droplets and/or frozen wastewater spheres. In some embodiments, a trommel separator is provided with multiple perforations or wire mesh. In some embodiments, the perforations are sized to collect the frozen ice shells while allowing liquid wastewater concentrate droplets and/or frozen wastewater spheres to fall to the bottom of the chamber.

In an example embodiment, the wastewater injection apparatus is configured to inject wastewater droplets having a size of approximately 1.5 mm in diameter, as disclosed herein. In the example, the frozen shell's outer diameters are greater than 1.5 mm and the frozen wastewater spheres are smaller than 1.5 mm in diameter. Therefore, the smaller wastewater core spheres may fall through the trommel separator toward the bottom of the chamber or into reservoirs. In some embodiments, the smaller core spheres fall through the perforated trommel separator onto a catcher slide so they slide downward to a collection area.

In some embodiments, FIG. 7 depicts the collection of frozen freshwater half shells resting on the perforated trommel separator at the bottom of the spray chamber. Many of the frozen spheres of concentrate may be smaller in diameter and fall through the holes in the perforated plate. In some embodiments, flash freezing with a strong temperature difference between droplet and surrounding super-chilled nitrogen results in hemispherical shells of freshwater. With proper sizing of the initial droplet diameter, gas temperature, and perforated drum hole sizing, separation of larger diameter hemispherical shells from smaller diameter spheres that separation may completed prior to deposition into the trommel separator. In some embodiments, the updraft speed of the gas drags the light weight and high drag coefficient hemispherical shells up toward the exit duct whereas the high density and low drag coefficient spheres would continue downward to the bottom of the spray chamber. In this case as well, separation may be completed prior to deposition of the of the concentrate spheres onto the into the trommel separator. However, when either of these two conditions are not met, the trommel separator may transfer and separate shells and spheres into the collection reservoirs.

In some embodiments, the drum of the trommel separator is composed of wire mesh with square hole dimension set at approximately 1.5 mm per side of the square. In some embodiments, separation of frozen hemispherical shells and froze core spheres from the mesh trommel separator is enhanced by the configuration of the mesh itself. In some embodiments, the mesh is composed of cylindrical wires that surround each opening. Thus, the points of contact between a hemisphere and point of contact of a sphere with the cylinder may limit the adhesive force to keep these frozen objects attached to the mesh.

In some embodiments, the larger hemispherical shells are transferred away from the spray chamber and through a thawing chamber. In some embodiments, one or more heaters are in thermal communication with the thawing chamber. In some embodiments, the temperature of the thawing chamber increases as the distance from the center of the spray chamber increases. Any smaller diameter frozen wastewater core spheres that did not fall through the mesh may liquefy, fall through the mesh, and drop onto the catcher surface for transfer away from the spray chamber.

Further design elements may be incorporated to assure that the shells and spheres do not adhere to the trommel separator and form an ever thickening layer that clogs the perforations. In some embodiments, a vibrational motion is imposed on the trommel separator to separate frozen particles from trommel drum. In some embodiments, trommel separator is heated. In some embodiments, the speed of the trommel is rotated is coordinated with the rate at which the frozen particles are deposited on it.

### B. Catcher

In some embodiments, the separation system further comprises a catcher/slide for transferring the frozen concentrate spheres. In some embodiments, the catcher/slide moves the spheres in a direction perpendicular to the thawing chamber to exit the thawing chamber. In some embodiments, moves the spheres into an inside portion of the trommel separator. In some embodiments, the slide/catcher is equipped with devices to prevent the ice spheres from adhering to its upper surface and accumulating as a solid and ever increasing in thickness. In some embodiments, the catcher is provided with a hydrophobic surface coating on at least its top surface. In some embodiments, the hydrophobic surface comprises PTFE. In some embodiments, the catcher is provided with a heating element.

In some embodiments, at the catcher draining surface extends to outside the spray chamber. In some embodiments, the catcher, comprises a vee-shape such that liquids drain and spheres roll/slide to its center. In some embodiments, the catcher surface is aligned with the trommel drum separator, such that any frozen wastewater spheres that are attached to the trommel separator are warmed to where the spheres liquefy and drop through the mesh and onto the catcher surface for removal.

In some embodiments, the catcher/slide surface is provided with a transducer that transmits vibration to the surface to assist in the rolling/sliding of the spheres along their downward descent toward the exit of the spray chamber. In some embodiments, the imparted vibration is parallel to the plane of the surface of the catcher. In some embodiments, the vibration is perpendicular to the surface of the catcher. In some embodiments, the vibration is circular. In some embodiments, the cyclic stress/strain of the vibration acts as a shear force to remove off any ice particles starting to attach to the catcher. In some embodiments, vibration occurs early in the deposition process when the attachment force is still weak. In some embodiments, a wire mesh is used in the trommel drum construction while a solid plate is used in the catcher/slide construction.

### IV. COLD AIR SOURCES

### A. Compander Output

In some embodiments, a compander is configured to deliver cold air to the freeze chamber. In some embodiments, the compander is a specific combination of turbocompressors and turboexpanders configured such that each turbocompressor is loaded by a turboexpander. In some embodiments, as depicted by FIG. 10A, compressed air from an air compressor 1410 flows through a succession of a first turbocompressor 1420, a second turbo compressor 1430, a first turboexpander 1425, and a second turboexpander 1435 to produce extremely cold air. This system may be referred to as a “compander” or “turbocompressor loaded turboexpander”. In some embodiments, to achieve the cold temperatures utilized for processing by the freeze chamber, use two stages of compression and two stages of expansion are utilized. This configuration produces a two-stage, free-spooling compander.

In some embodiments, heat exchangers 1450, 1455 are provided to remove the heat generated from air compression. In some embodiments, the heat exchangers provide heat to another component of the system. In some embodiments, the heat exchangers provide heat to one or more heaters of a thawing channel of a freeze chamber.

FIG. 10B depicts exemplary thermodynamic properties at specific points in the compander configuration, wherein the properties correspond to the points depicted in FIG. 10A. The isentropic law may be used to describe the expansion process. The known efficiency of air compressors and turbocompressors may provide the loss of enthalpy during each stage of the compression process. According to some embodiments, FIG. 12 depicts the calculation for Compressor 1410, as depicted in FIG. 10A. The power requirement uses the mass flow of air (Pounds per Hour) and the thermodynamic values (BTU/Pound) to show the required power (BTU/Hr).

The compander system is extremely efficient for generating high mass flows of air at low temperatures compared to any piston system. In some embodiments, it is the Compander that supplies the cold air and the droplets that are mixed with this air that results in high efficiency separation of fresh water from input wastewater streams, even streams with high concentrations of contaminants. Furthermore, the contaminants can be extremely damaging to RO membranes but not influence the Spray Chamber performance.

The compression of air may be accompanied by an increase in temperature. In an example embodiment, a 90 psig air compressor exhausts air at +250° F. In some embodiments, the hot pressurized flowing air is passed through a heat exchanger such that its temperature is returned to 70° F. while retaining most of the pressure. Pressure may then be reduced to atmospheric pressure to achieve cold air temperature air flow. In some embodiments, the process uses turbine technology and high mass flows are achieved with thermodynamic efficiency. Furthermore, if the compander process is done in two stages, air temperatures of −175° F. may be achieved.

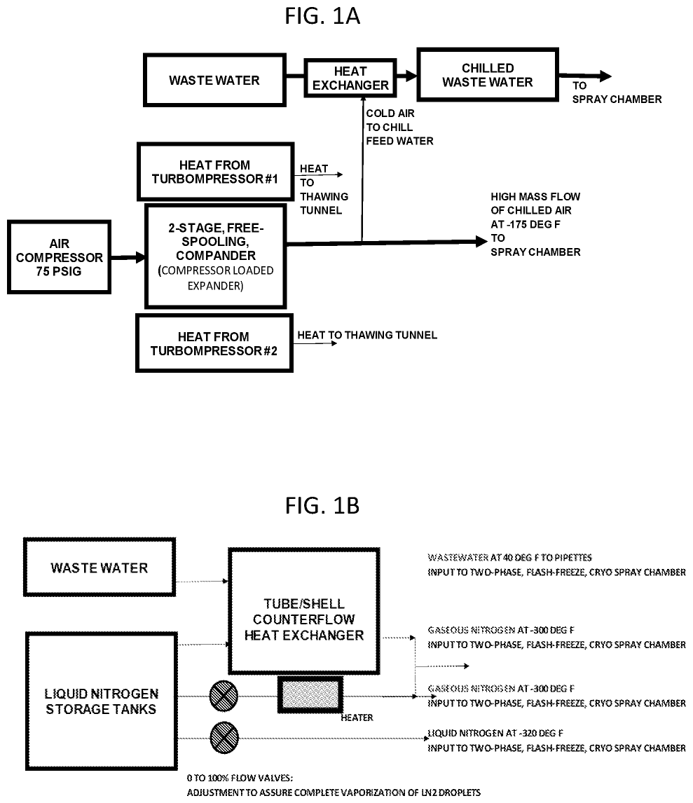

With reference to FIG. 1A, a heat exchange process of a processing system using a compander is depicted, according to some embodiments. In some embodiments, an air compressor outputs compressed air to the compander system. Heat from the turbocompressors of the compander system may be sourced to the thawing tunnel of one or more freeze chambers. The cold air produced by the compander system may be fed to the freeze chamber(s) to provide the cold air stream necessary to freeze at least the pure water of the wastewater droplets. In some embodiments, the cold air produced by the compander is further used to cool the wastewater prior the wastewater being injected into the one or more freeze chambers.

The heat exchange process in the overall system presented herein is one wherein cold gas is generated to freeze and separate the fresh water from the wastewater and later hot gas is generated to warm the hemispherical ice shells and even warm the frozen spherical cores of highly concentrated solution. The combination of turbocompressors that generate the heat and turboexpanders that generate the cold are managed at different points in the overall process at specified times. In some embodiments, the system is configured to freeze the spherical droplet to produce only a freshwater ice shell and liquid spherical core. In some embodiments, the system is configured to freeze the spherical wastewater core after the freshwater ice shell has departed.

In some embodiments, the compander system may be portable. In some embodiments, the compander system may be provided on a towable trailer and transported to a processing site. FIG. 1B depicts an embodiment, wherein liquid nitrogen storage tanks are utilized in addition to, or instead of, a compander.

### B. Liquefied Gas Output

Advantages of the freeze processing technology may include the ability to utilize the cold energy from the regasification of liquefied gas (i.e., compounds, elements, or other substances which are normally in a gaseous state at atmospheric pressure and/or room temperatures). Liquefied gas sources may include liquid natural gas (LNG), nitrogen, carbon dioxide, or other suitable liquefied gas sources. In an example embodiment, freeze processing utilizing a liquid natural gas source at the manufacturer's location has a low operating cost of 0.34$/m³ compared to 0.75$/m³ for a commonly used reverse osmosis (RO) desalination technology.

In some embodiments, a heat exchange system is provided for the liquefied gas output, as depicted in FIG. 10B. In some embodiments, the liquefied gas is released from storage tanks as cold gas and fed directly into a freeze chamber. In some embodiments, one or more flow valves control the feed of cold gas from the liquefied gas storage tanks to the system. In some embodiments, at least a portion of the liquefied gas is directed to a heat exchanger. The heat exchanger may mix the wastewater source with the cold gas to reduce the temperature of the wastewater prior to injection into a freeze chamber.

### V. COMBINATION OF WATER PROCESSING SYSTEMS

### A. Multiple Freeze Chamber System

For highly contaminant laden wastewater streams beyond treatment by reverse osmosis, the spray chamber system may include a large spray chamber system followed by additional treatment by a small spray chamber. In some embodiments, the small spray chamber comprises a single injector. In some embodiments, the small spray chamber comprises a small footprint to be provided as a household or workplace processing system. In some embodiments, the small chamber utilizes liquid gas for the cold air source.

B. Use with Reverse Osmosis System

In some embodiments, the water processing system comprises a large spray chamber system followed by a reverse osmosis system. The spray chamber may treat wastewater having a contaminant concentration too high to be treated practically by a reverse osmosis system. In some embodiments, the output from the spray chamber is at a concentration treatable by a reverse osmosis system. In some embodiments, the combined reverse osmosis and freeze chamber processing may produce fresh water from highly concentrated waste streams at lower required power levels. In some embodiments, wherein the concentration of contaminants is greater than a eutectic condition, minerals/contaminants, eutectic concentrate, and potable water are recovered by the freeze chamber. In some embodiments, wherein the concentration of contaminants is less than the eutectic condition, but greater than practically treatable by a reverse osmosis system, eutectic concentrate and potable water are recovered by the freeze chamber. In some embodiments, a reverse osmosis system is used to further process water from an output of the freeze chamber. In some embodiments, an ion exchange process is utilized to further process the fresh water.

In some embodiments, wherein reverse osmosis systems are in place and produce output having high concentrations of contaminants, a spray chamber may be provided downstream of the reverse osmosis system. The spray chamber may be utilized to separate byproducts in from an output of the reverse osmosis stream having an unacceptably high concentration of retentate. The spray chamber may treat the rejected wastewater stream from the reverse osmosis to generate potable water and recover contaminants. The system may provide processing with zero waste.

In an example, consider reverse osmosis system of a 100,000 gallon per day (GPD) system, processing water with 3% concentration of salt. The reverse osmosis system may provide 80% recovery, with a rejected stream of 20,000 gallons at 15% concentration of salt. Thus, the spray chamber feed may process only 20,000 GPD to support a 100,000 GPD reverse osmosis system.

### VI. DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative, or quantitative and qualitative determinations. Assessing can be relative or absolute. “Detecting the presence of” can include determining the amount of something present in addition to determining whether it is present or absent depending on the context.

As used herein, the term “about” a number refers to that number plus or minus 10% of that number. The term “about” a range refers to that range minus 10% of its lowest value and plus 10% of its greatest value.

As used herein, the term “water” is used in reference to dihydrogen monoxide (H₂O) which may be in any phase (e.g., liquid water, solid ice, gas steam). The term “water” may refer to mostly pure water, potable water, or a water solution with a high concentration of pure water (e.g., 98% or greater pure water in some embodiments).

The section headings used herein are for organizational purposes only and are not to be construed as limiting the subject matter described.

### VII. EXEMPLARY EMBODIMENTS

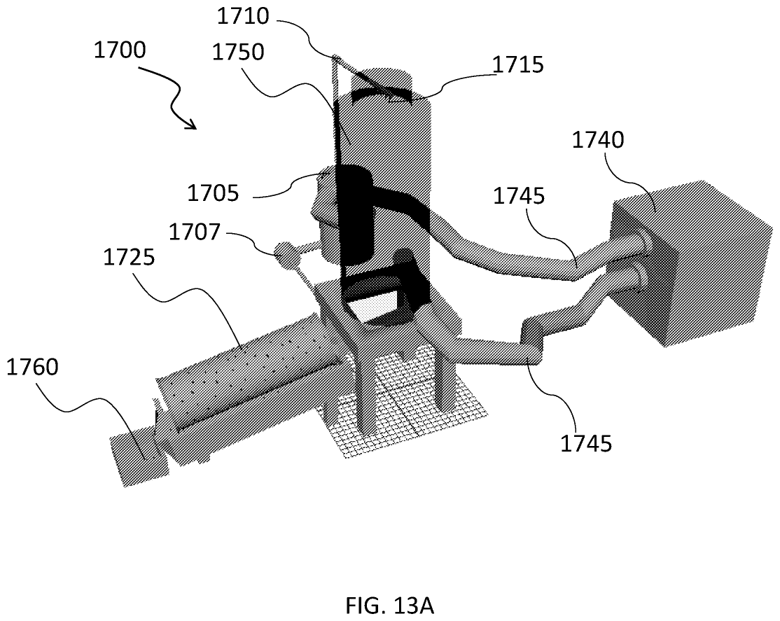

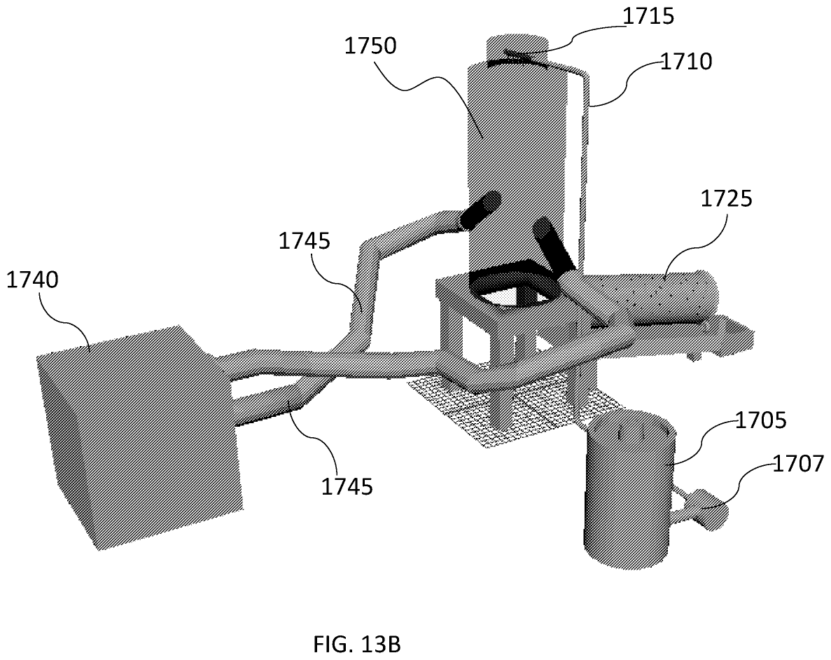

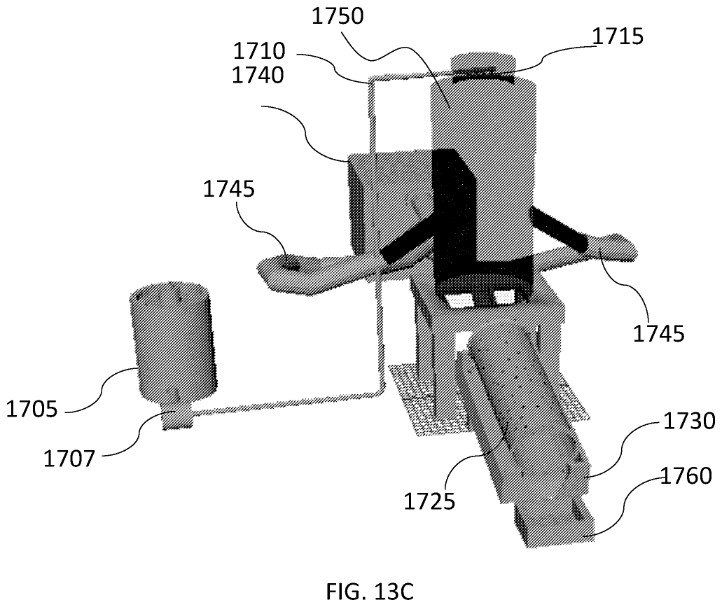

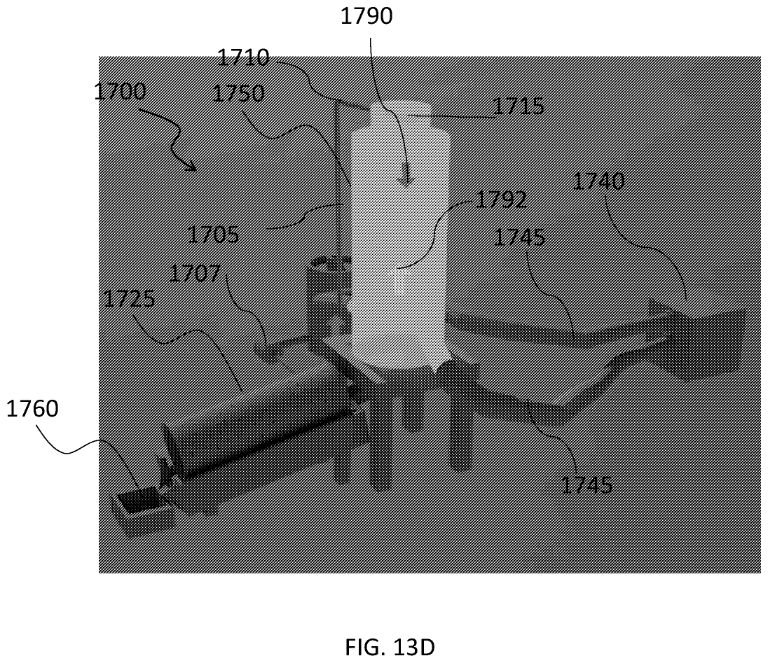

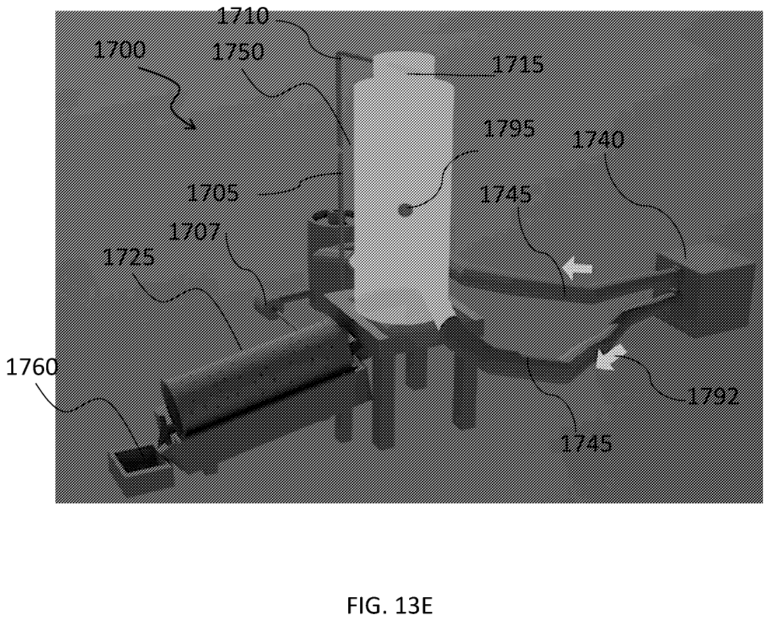

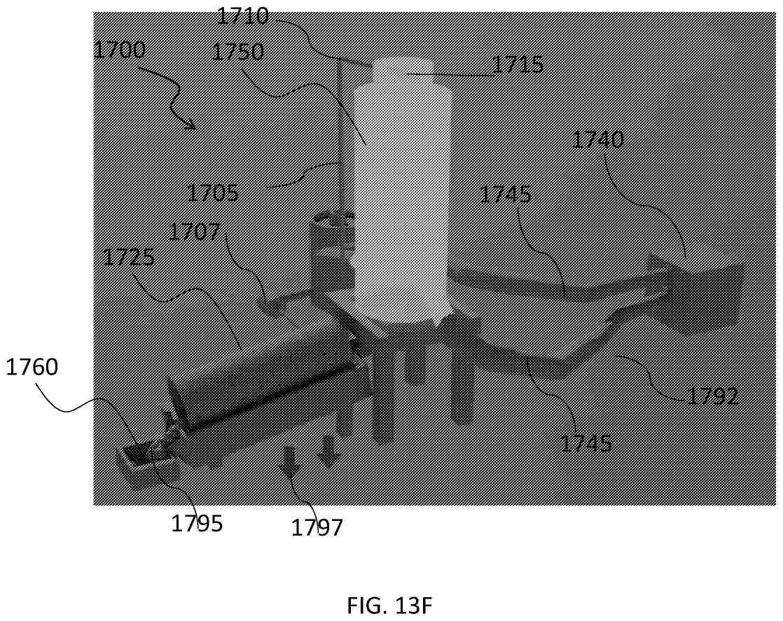

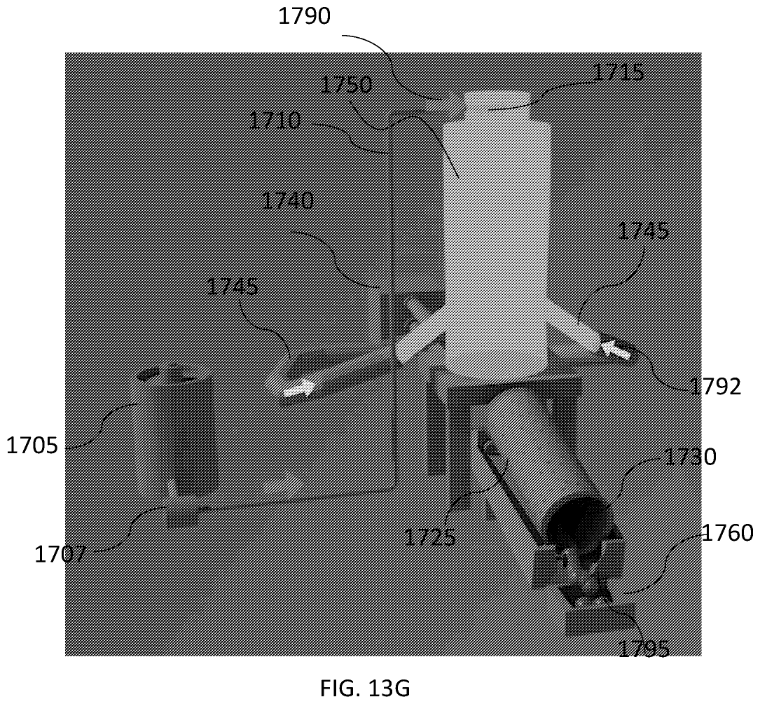

FIGS. 13A-13C depict an exemplary wastewater processing system 1700, according to some embodiments. In some embodiments, a wastewater processing system comprises a wastewater processing chamber 1750.

In some embodiments, the wastewater processing chamber 1750 is configured as a freeze chamber, as disclosed herein. In some embodiments, wastewater is pumped from a wastewater source 1705 by a liquid pump 1707. In some embodiments, the wastewater source is a tank. In some embodiments, the tank comprises a lid which is removable such that additional wastewater can be added to the tank. In some embodiments, the tank, the pump, or both comprise one or more filters for filtering out solid particulate from the wastewater.

In some embodiments, wastewater is pumped through a liquid line or pipe 1710. In some embodiments, the wastewater is injected into the chamber 1750 via an injection nozzle array 1715. In some embodiments, the nozzle array comprises a plurality of nozzles from by extended pipes or tubes in fluid communication with the pipe 1710. In some embodiments, the nozzles are configured to inject wastewater into the chamber as a stream of droplets. In some embodiments, the inner diameter of the nozzles of the array 1715 are sized to produce droplets having a diameter suited for rapid freeze separations as disclosed herein.

In some embodiments, cold air is supplied to the chamber 1750 via a compander 1740, as disclosed herein. In some embodiments, two cold air supply lines 1745 receive cold air from the compander 1740 and direct the cold air into the chamber 1750. In some embodiments, the cold air supply lines 1745 introduce the cold air at opposing sides of the chamber diameter. In some embodiments, the cold supply lines direct the cold air up toward the top of the chamber to create an updraft of cold air (also referred to as a counter-flow arrangement herein) into the chamber.

In some embodiments, the chamber 1750 comprises an outlet at the bottom of the chamber. In some embodiments, the outlet directs byproducts of freeze separation within the chamber 1750 to a byproduct separation system 1725. In some embodiments, the byproduct separation system comprises a trommel separator. In some embodiments, the trommel separator comprises a barrel or tube having perforations. In some embodiments, the trommel is placed at an angle such that the byproducts are transported toward an ice collection basket or tray 1760 under the assistance of gravity. In some embodiments, the trommel is rotated. The rotating and angled trommel allows from liquid waste byproducts to fall through the perforations as purified water (in the form of ice) is transported into the ice collection basket.

FIGS. 13D-13G depict an exemplary wastewater processing system 1700 in operation, according to some embodiments. In some embodiments, the wastewater 1790 to be processed is feed into the processing chamber 1750 via pipe 1710. In some embodiments, as depicted in FIG. 13D, the wastewater 1790 is injected into the chamber 1750 via the array of nozzles 1715, such that the droplets of wastewater are the appropriate size for efficient freeze separation as disclosed herein. In some embodiments, the wastewater droplets fall through the chamber 1715 as the cold air 1792 is feed into chamber via cold air supply lines 1745. In some embodiments, as depicted in FIG. 13D, the cold air 1792 enters from the bottom of the chamber, directed upward, as the wastewater 1790 falls toward the bottom of the chamber. This chamber configuration may be referred to as an updraft configuration. In some embodiments, the updraft configuration allows for a smaller chamber height than other configurations.

In some embodiments, as depicted in FIG. 13E, as the wastewater droplets are met by the cold air, the water of the droplet freezes to form a pure ice sphere 1795 while separating from the wastewater byproduct in an explosive freeze separation process, as described herein. In some embodiments, the wastewater byproducts and the pure ice spheres 1795 fall to the bottom of the chamber under the influence of gravity.

In some embodiments, as depicted in FIG. 13F, the bottom of the chamber comprises a byproduct separation system 1725. In some embodiments, the byproduct separation system 1725 comprises a trommel separator. In some embodiments, the trommel separator comprises a barrel or tube having perforations. In some embodiments, the trommel is placed at an angle such that the pure ice spheres 1795 are transported into an ice collection basket or tray 1760 under the assistance of gravity. In some embodiments, the trommel is rotated. The rotating and angled trommel allows liquid waste byproducts 1797 to fall through the perforations as purified water (in the form of ice) 1795 is transported into the ice collection basket 1960.

FIG. 13G depicts another view of the wastewater processing system 1700 during operation.

### VIII. EXAMPLES

The following examples are included for illustrative purposes only and are not intended to limit the scope of the invention.

### Example 1: Processing of 100,000 Gallons of Wastewater Per Day

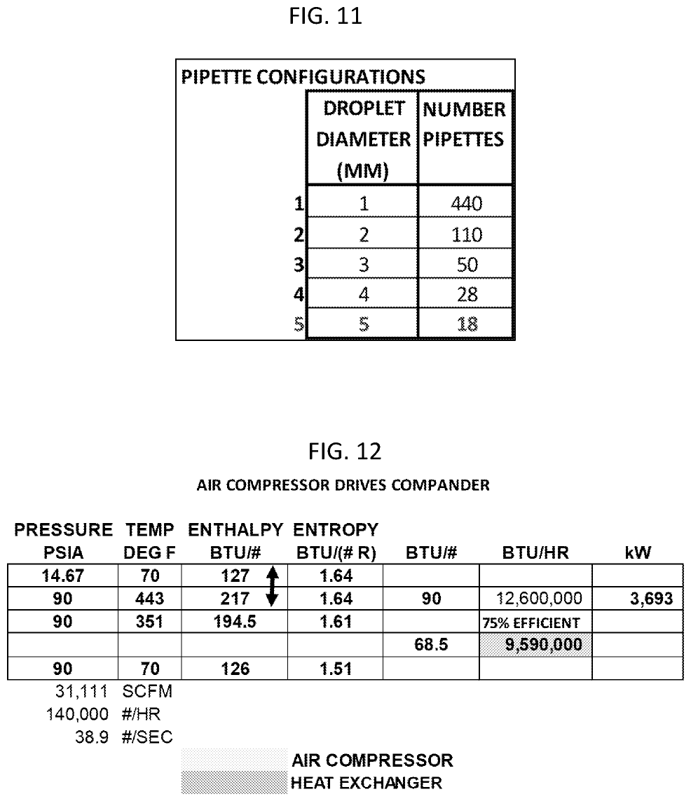

FIG. 11, depicts the number of injectors needed to achieve the same output of 100,000 gallons of processed wastewater in a day using different droplet diameters. The results depict that use of an injector array configured to produce wastewater droplets 1.5 mm or larger permits a higher daily output with fewer injectors. Additionally, the larger droplet sizes allow for large hemispherical shells which are easier to separate and filter from the concentrated wastewater cores upon freezing.

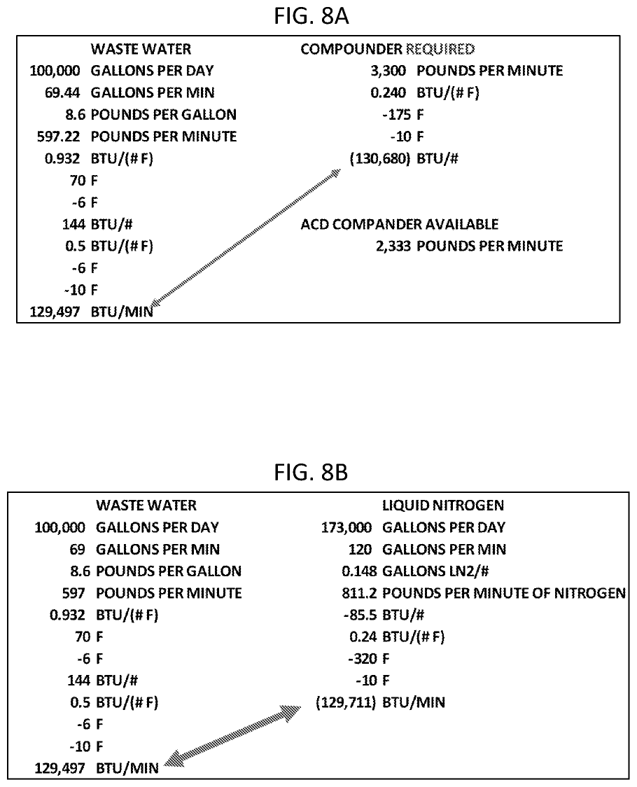

FIG. 8A depicts the necessary requirements for a compander to produce an output of approximately 130,000 British thermal units/per minute (BTU/min) necessary to process 100,000 gallons of wastewater per day. For this example, consider a final droplet and gas mixture at −10° F. for NaCl. The depicted calculations are based upon no heat losses or pressure drops to avoid complexity. Rather, the −10° F. target for a eutectic temperature of −5.8° F. will help give more practical results. Perfect mixing of 100,000 Gallons per Day of Saltwater with 3,000 pounds per minute of −145° F. air from a Compander will produce ice shells, liquid droplet cores (in the middle level of the spray chamber), and frozen droplet cores (in the bottom level of spray chamber)

FIG. 8B depicts the necessary requirements for a liquid nitrogen system to produce an output of approximately 130,000 British thermal units/per minute (BTU/min) necessary to process 100,000 gallons of wastewater per day. In some embodiments, liquid nitrogen is not fed directly into the spray chamber. The latent heat of vaporization of the liquid nitrogen may be used to chill the input wastewater. Since there may not be enough wastewater to be processed to gasify all the required liquid nitrogen, the extra liquid nitrogen may be warmed with heat drawn from the ground or a gas heater.

Hemispherical shells of frozen freshwater ice and the spherical cores of frozen concentrate must pass through a zone of extremely cold air and brought to a temperature slightly colder than the eutectic temperature. Thus, the nearby air of −175° F. or the nearby nitrogen gas of −300° F. needs to be separate from the fragments that are now at −10° F. (for NaCl contaminant). It may be required that the particles deposit into the trommel separator at −10° F. so that the fresh frozen water of the ice shells be warmed but stay ice but the concentrate liquefy. This ice may float atop the dense liquid.

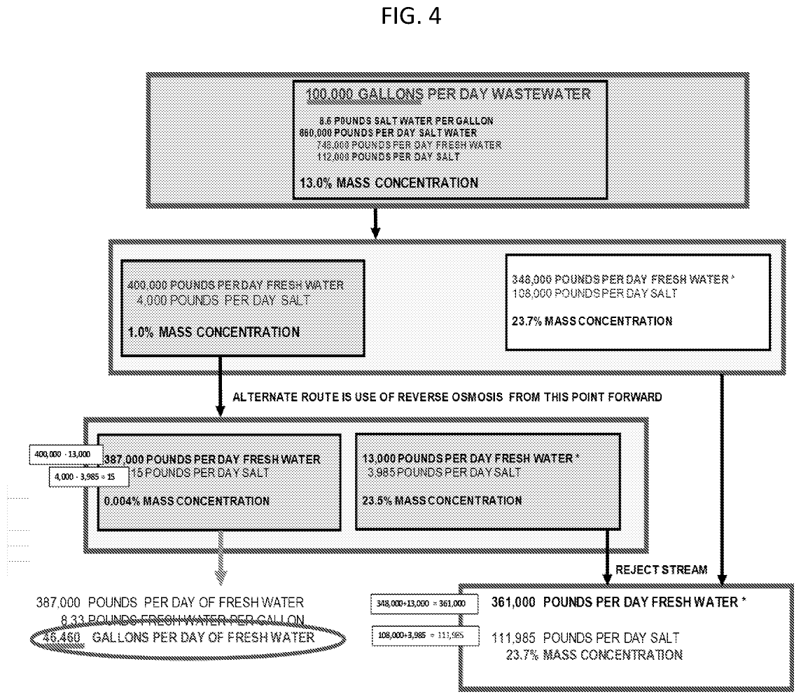

FIG. 4 depicts an approximation to describe how freeze crystallization process operates to obtain high purity of water. The lever rule is used to accurately calculate the output of fresh water. When there is a mixture of just NaCl and water, the recovery of water is almost 100%. When there is a complex mixture, the recovery of water may be strongly reduced, but there is crystal recovery.

FIG. 4 depicts an additional consideration of utilizing an additional spray chamber. When a second spray chamber is introduced, there may be a Lower flow rate and an associated concentration that a reverse osmosis membrane can process. There is a capital cost and operational cost savings and space savings that can be achieved may be achieved by combining the spray chamber processing system with existing reverse osmosis systems. The combination of spray chamber and reverse osmosis may create a unique capability in treating high concentration wastewater streams with efficiencies not previously available.

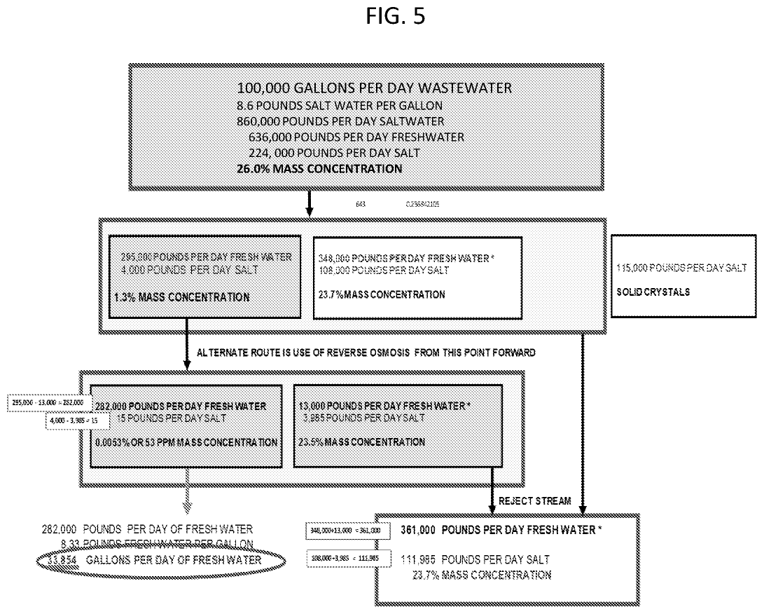

FIG. 5 repeats the calculations of FIG. 4 but considers a salt solution (binary system) with a concentration raised from 13% to 26%. Recall that the eutectic concentration is 23.3% for NaCl crystals in solution with water. Thus, the salt concentration considered in FIG. 5 (26%) exceeds the eutectic concentration (23.3%). This condition may be referred to as hypersaline. When the temperature of the binary system is chilled to the eutectic temperature (−5.8° F. for NaCl), the system will appear with freshwater ice floating on top of a solution at the eutectic concentration.

For this example, consider a final droplet and gas mixture at −10° F. for NaCl. The calculations are based upon no heat losses or pressure drops to avoid complexity. Rather, the −10° F. target for an NaCl solution will help give more practical results.

Perfect mixing of 100,000 gallons per day of a hypersaline saltwater solution with 3,000 pounds per minute of −145° F. air from a Compander may result in forming ice shells, liquid droplet cores (at a middle level of the spray chamber), and frozen droplet cores (at a bottom level of spray chamber).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A wastewater processing system comprising:
a chamber comprising:
a liquid inlet comprising one or more injectors to provide wastewater into the chamber, wherein the wastewater exits each of the one or more injectors as a liquid column and separates into wastewater droplets;
one or more cold gas inlets for directing cold gas to the wastewater droplets inside the chamber, wherein the cold gas is provided at a temperature at or below a eutectic temperature of the wastewater; and
a gas outlet to exhaust the cold gas from the chamber;
wherein exposure of the wastewater droplets to the cold gas causes separation of water from contaminants in the wastewater droplets.

2. The system of claim 1, wherein the chamber is oriented vertically.

3. The system of claim 2, wherein the liquid inlet is provided near a top portion of the chamber.

4. The system of claim 3, wherein the gas inlet is provided at a position below the gas outlet such that a flow direction the cold gas opposes a flow direction of the wastewater.

5. The system of claim 3, wherein the gas inlet is provided at a position below the gas outlet such that a flow direction of the cold gas is the same as a flow direction of the wastewater.

6. The system of claim 1, wherein the liquid inlet comprises an injector assembly.

7. The system of claim 6, wherein the injector assembly comprises at least one circular manifold comprising the at least one injectors.

8. The system of claim 6, wherein the injector assembly comprises at least two circular manifolds.

9. The system of claim 8, wherein the at least two manifold are arranged concentrically.

10. The system of claim 8 or 9, wherein each manifold comprises at least two injectors.

11. The system of any one of claims 1 to 10, wherein the liquid inlet is configured to provide the wastewater into the chamber at a pressure of approximately 10 pounds per square inch gauge.

12. The system of any one of claims 1 to 11, wherein the liquid inlet is configured to produce wastewater droplets having a diameter of approximately 1.5 millimeters or greater.

13. The system of any one of claims 1 to 12, wherein the chamber further comprises a liquid outlet.

14. The system of claim 13, wherein the gas inlet is provided at a position below the gas outlet such that a flow direction of the cold gas opposes a flow direction of the wastewater, and wherein the liquid outlet is positioned above the gas inlet.

15. The system of claim 13, wherein the liquid outlet is configured to remove liquid contaminant separated from the wastewater.

16. The system of any one of claims 1 to 12, wherein at least a portion of the water separated from the contaminants comprises solid phase ice particles, and wherein the chamber further comprises an ice particle outlet to remove the ice particles from the chamber.

17. The system of claim 16, wherein the gas inlet is provided at a position below the gas outlet such that a flow direction of the cold gas opposes a flow direction of the wastewater, and wherein the ice particle outlet is positioned above the gas inlet.

18. The system of any one of claims 1 to 17, wherein the chamber further comprises a thawing channel.

19. The system of claim 18, wherein the thawing channel is provided below the gas inlet.

20. The system of claim 18 or 19, wherein the thawing channel is provided below the gas outlet.

21. The system of claim 20, wherein the thawing channel is provided within a dead volume space.

22. The system of claim 21, wherein the dead volume space is located below the gas inlet and the gas outlet at a distance greater than or equal to 4 equivalent chamber diameters.

23. The system of any one of claims 18 to 22, wherein the thawing channel comprises one or more heaters.

24. The system of claim 23, wherein the one or more heaters are provided against and exterior surface of the thawing channel such that heat is conducted from the one or more heaters into the thawing channel.

25. The system of claim 23 or 24, wherein the one or more heaters are heat exchangers.

26. The system of claim 25, wherein the heat exchangers comprise a cold side, and wherein the cold side conducts to HVAC system, cold storage system or combination thereof.

27. The system of any one of claims 18 to 26, further comprising a trommel separation system.

28. The system of claim 27, wherein the trommel separation system is provided in the thawing channel.

29. The system of any one of claims 1 to 26, further comprising a trommel separator system.

30. The system of any one of claims 27 to 29, wherein the trommel separator system comprises a rotating trommel drum.

31. The system of claim 30, wherein the rotating trommel drum comprises perforations.

32. The system of claim 31, wherein the perforations are substantially circular.

33. The system of claim 32, wherein the perforations have a diameter of approximately 1.5 millimeters.

34. The system claim 30, wherein the rotating trommel drum comprises a wire mesh.

35. The system of claim 34, wherein the wire mesh comprises a plurality of square holes.

36. The system of claim 35, wherein each square hole of the plurality of square holes comprises a side dimension of approximate 1.5 millimeters.

37. The system of any one of claims 27 to 36, wherein trommel separator system further comprises a liquid catcher.

38. The system of claim 37, wherein the liquid catcher comprises a low-friction top surface.

39. The system of claim 38, wherein the low-friction top surface is a hydrophobic surface.

40. The system of claim 39, wherein the low-friction top surface comprises Polytetrafluoroethylene (PTFE).

41. The system of any one of claims 37 to 40, wherein the liquid catcher comprises a heating element.

42. The system of any one of claims 1 to 41, wherein the chamber comprises perforated sidewalls.

43. The system of claim 42, wherein the perforated sidewalls are configured as a heated gas inlet.

44. The system of claim 43, further comprising an air compressor, wherein heated gas is sourced to the heated gas inlet from an air compressor.

45. The system of claim 44, further comprising a compander, wherein the air compressor supplies compressed air to an inlet of the compander.

46. The system of claim 42, further comprising a first air compressor wherein heated exhaust air from the first air compressor is passed through the perforated sidewalls, wherein the heated exhaust air heats the perforated sidewalls and forces ice particles away from the perforated sidewalls.

47. The system of claim 46, wherein the heated exhaust air buoyantly transfers ice particles to the gas outlet.

48. The system of claim 46 or 47, further comprising a second air compressor and a compander, wherein the second air compressor supplies compressed air to an inlet of the compander.

49. The system of any one of claims 42 to 48, wherein the perforated sidewalls are positioned between the cold gas inlet and the cold gas outlet.

50. The system of any one of claims 1 to 41, further comprising one or more reservoirs to collect byproducts created by the exposure of the wastewater to the cold gas.

51. The system of claim 50, wherein at least one of the one or more reservoirs is a purified water reservoir for collecting at least some of the water.

52. The system of claim 51, wherein the chamber further comprises a purified water outlet configured to remove the water from the purified water reservoir.

53. The system of any one of claims 50 to 52, wherein at least one of the one or more reservoirs is a contaminated byproduct reservoir for collecting at least some of the contaminants.

54. The system of claim 53, further comprising a liquid contaminant outlet configured to remove a contaminated liquid byproduct containing at least some of the contaminants from the from the contaminated byproduct reservoir.

55. The system of claim 54, further comprising a second chamber configured to process the contaminated liquid byproduct sourced from the contaminated byproduct reservoir.

56. The system of claim 54, further comprising a reverse osmosis device configured to process the contaminated liquid byproduct sourced from the contaminated byproduct reservoir, wherein said contaminated liquid byproduct is a reduced concentration liquid byproduct.

57. The system of any one of claims 1 to 54, further comprising a preliminary processing chamber, and wherein the wastewater is sourced from the preliminary processing chamber.

58. The system of any one of claims 1 to 54, wherein the wastewater is sourced from a reverse osmosis device.

59. The system of claim 58, wherein the wastewater sourced from the reverse osmosis device is an unacceptable high concentration retentate.

60. The system of any one of claims 1 to 59, wherein the cold gas is sourced from a compressed gas system.

61. The system of claim 60, wherein the compressed gas system comprises a liquid nitrogen system.

62. The system of any one of claims 1 to 58, wherein the system further comprises a compander, wherein the compander supplies the cold gas to the cold gas inlet.

63. A method for processing wastewater comprising:
introducing wastewater into an insulated space;
injecting a cold gas into the insulated space
mixing the wastewater with the cold gas; and
collecting byproducts created by the mixing of the wastewater with the cold gas.

64. The method of claim 63, wherein the byproducts comprise water, ice particles, or a combination thereof.

65. The method of claim 63 or 64, further comprising a step of segregating the byproducts.

66. The method of claim 65, wherein the byproducts are collected in at least one byproduct reservoir.

67. The method of claim 66, wherein the step of segregating the byproducts comprises conveying ice particles to a purified water reservoir.

68. The method of claim 66 or 67, wherein the step of segregating the byproducts comprises collecting contaminated liquid in a contaminated byproduct reservoir.

69. The method of any one of claims 66 to 68, further comprising a step of removing the byproducts from the insulated space.

70. The method of claim 69, further comprising a step of processing at least one of the byproducts removed after the step of removing the byproducts from the insulated space.

71. The method of claim 70, wherein the step of processing at least one of the byproducts comprises filtering the at least one of the byproducts by reverse osmosis.

72. The method of any one of claims 63 to 71, wherein the wastewater comprises water and at least one contaminant.

73. The method of claim 72, wherein the eutectic temperature of the wastewater is a eutectic temperature of the at least one contaminant.

74. The method of claim 73, wherein the wastewater comprises two or more contaminants, wherein the eutectic temperature of the wastewater is a lowest eutectic temperature of the two or more contaminants.

75. The method of any one of claims 63 to 74, further comprising a step of heating a portion of the insulated space.

76. The method of claim 75, wherein the step of heating a portion of the insulated space comprises heating an inner wall of the insulated space.

77. The method of any one of claims 63 to 76, wherein the step of mixing the wastewater with the cold gas comprises flowing the cold gas in the opposite direction of a flow of the wastewater.

78. The method of any one of claims 63 to 75, wherein the step of mixing the wastewater with the cold gas comprises flowing the cold gas in the same direction of a flow of the wastewater.

79. The method of any one of claims 63 to 78, wherein the wastewater is introduced into the insulated space via one or more injectors.

80. The method of any one of claims 63 to 79, wherein the wastewater is introduced into the insulated space as droplets.

81. The method of claim 80, wherein a diameter of the droplets is approximately 1.5 millimeters or greater.

82. The method of claim 80 or 81, wherein the droplets are spherical.

83. The method of any one of claims 63 to 81, wherein the insulated space is provided by a processing chamber, wherein the processing chamber comprises the chamber as disclosed by any one of claims 1 to 43.

84. A wastewater processing system comprising:
a first chamber comprising:
a first liquid inlet to provide wastewater into the first chamber;
a first cold gas inlet to direct a first cold gas to the wastewater inside the first chamber, wherein exposure of the wastewater to the first cold gas separates the wastewater into two or more byproducts, wherein the two or more byproducts comprise at least one liquid byproduct;
a first gas outlet to exhaust the first cold gas from the first chamber; and
a first liquid outlet to remove the at least one liquid byproduct from the first chamber;
and
a second chamber comprising:
a second liquid inlet to introduce the at least one liquid byproduct from the first chamber into the second chamber;
a second cold gas inlet to direct a second cold gas to the at least one liquid byproduct inside the second chamber; and
a second gas outlet to exhaust the second cold gas from the second chamber,
wherein exposure of the at least one liquid byproduct to the second cold gas separates water or ice from contaminants of the at least one liquid byproduct.

85. The system of claim 84, wherein a flow direction the first cold gas opposes a flow direction of the wastewater.

86. The system of claim 84 or 85, wherein a flow direction the second cold gas opposes a flow direction of at least one liquid byproduct.

87. The system of claim 84, wherein a flow direction the first cold gas is the same as a flow direction of the wastewater.

88. The system of claim 84 or 85, wherein a flow direction the second cold gas is the same as a flow direction of at least one liquid byproduct.

89. The system of any one of claims 84 to 88, wherein at least one of the first liquid inlet or the second liquid inlet comprise at least one injector.

90. The system of claim 89, wherein the at least one of the first liquid inlet or the second liquid inlet comprises an injector assembly.

91. The system of claim 90, wherein the injector assembly comprises at least one circular manifold comprising the at least one injector.

92. The system of claim 90 or 91, wherein the injector assembly comprises at least two circular manifolds.

93. The system of claim 92, wherein the at least two manifold are arranged concentrically.

94. The system of claim 92 or 93, wherein each manifold comprises at least two injectors.

95. The system of any one of claims 89 to 94, wherein the first liquid inlet of the first chamber comprises more injectors than the second liquid inlet of the second chamber.

96. The system of any one of claims 84 to 95, wherein at least one of the first liquid inlet or the second liquid inlet is configured to provide the wastewater into the chamber at a pressure of approximately 10 pounds per square inch gauge.

97. The system of any one of claims 84 to 96, wherein at least one of the first liquid inlet or the second liquid inlet is configured to produce wastewater droplets having a diameter of approximately 1.5 millimeters or greater.

98. The system of any one of claims 84 to 97, wherein the first chamber further comprises a first thawing channel.

99. The system of claim 98, wherein the first thawing channel comprises one or more heaters.

100. The system of claim 99, wherein the one or more heaters are provided against and exterior surface of the first thawing channel such that heat is conducted from the one or more heaters into the first thawing channel.

101. The system of claim 99 or 100, wherein the one or more heaters of the first chamber are heat exchangers.

102. The system of claim 101, wherein the heat exchangers of the first chamber comprise a cold side, and wherein the cold side conducts to a HVAC system, cold storage system or combination thereof.

103. The system of any one of claims 84 to 102, wherein the second chamber further comprises a second thawing channel.

104. The system of claim 103, wherein the second thawing channel comprises one or more heaters.

105. The system of claim 104, wherein the one or more heaters are provided against and exterior surface of the second thawing channel such that heat is conducted from the one or more heaters into the first thawing channel.

106. The system of claim 104 or 105, wherein the one or more heaters of the second chamber are heat exchangers.

107. The system of claim 106, wherein the heat exchangers of the first chamber comprise a cold side, and wherein the cold side conducts to HVAC system, cold storage system or combination thereof.

108. The system of any one of claims 84 to 107, wherein at least one of the first or second chambers further comprise a trommel separation system.

109. The system of claim 108, wherein the trommel separation system comprises rotating trommel drum.

110. The system of claim 109, wherein the rotating trommel drum comprises perforations.

111. The system of claim 110, wherein the perforations are substantially circular.

112. The system of claim 111, wherein the perforations have a diameter of approximately 1.5 millimeters.

113. The system claim 109, wherein the rotating trommel drum comprises a wire mesh belt.

114. The system of claim 113, wherein the wire mesh belt comprises a plurality of square holes.

115. The system of claim 114, wherein each square hole of the plurality of square holes comprises a side dimension of approximate 1.5 millimeters.

116. The system of any one of claims 108 to 115, wherein the trommel separation system further comprises a liquid catcher.

117. The system of claim 116, wherein the liquid catcher comprises a low-friction top surface.

118. The system of claim 117, wherein the low-friction top surface is a hydrophobic surface.

119. The system of claim 118, wherein the low-friction top surface comprises Teflon.

120. The system of any one of claims 116 to 119, wherein the liquid catcher comprises a heating element.

121. The system of any one of claims 84 to 120, wherein at least the first chamber comprises perforated sidewalls.

122. The system of claim 121, wherein the perforated sidewalls are configured as a heated gas inlet.

123. The system of claim 122, further comprising an air compressor, wherein heated gas is sourced to the heated gas inlet from the air compressor.

124. The system of claim 123, further comprising a compander, wherein the air compressor supplies compressed air to an inlet of the compander.

125. The system of any one of claims 121 to 124, wherein the perforated sidewalls are positioned between the first cold gas inlet and the first cold gas outlet.

126. The system of any one of claims 84 to 125, wherein the second cold gas is sourced from a compressed gas system.

127. The system of any one of claims 84 to 126, wherein the first cold gas is sourced from a compressed gas system.

128. The system of claim 126 or 127, wherein the compressed gas system comprises a liquid nitrogen system.

129. A method for processing wastewater comprising:
introducing wastewater into a first insulated space;
injecting a first cold gas into the first insulated space
mixing the wastewater with the first cold gas;
collecting first byproducts created by the mixing of the wastewater with the first cold gas, wherein the byproducts comprise at least one liquid byproduct;
removing the at least one liquid byproducts from the first insulated space;
introducing the at least one liquid byproduct into a second insulated space;
injecting a second cold gas into the second insulated space;
mixing the at least one liquid byproduct with the second cold gas;
collecting second byproducts created by the mixing of the at least one liquid byproduct with the second cold gas.

130. The method of claim 129, wherein the first byproducts comprise water, ice particles, or a combination thereof.

131. The method of claim 129 or 130, wherein the second byproducts comprise purified water, purified ice, or a combination thereof.

132. The method of any one of claims 129 to 131, further comprising a step of segregating the first byproducts with the first insulated space.

133. The method of claim 132, wherein the first byproducts are collected in at least one first byproduct reservoir.

134. The method of claim 133, wherein the step of segregating the first byproducts comprises conveying ice particles to a first water reservoir.

135. The method of any one of claims 132 to 134, wherein the step of segregating the first byproducts comprises collecting contaminated liquid in a first contaminated byproduct reservoir.

136. The method of any one of claims 129 to 135, wherein the wastewater comprises water and at least one first contaminant.

137. The method of claim 136, wherein the first cold gas is injected into the first insulated space at or below a eutectic temperature of the at least one first contaminant.

138. The method of claim 136, wherein the wastewater comprises two or more first contaminants, wherein the first cold gas is injected at or below a lowest eutectic temperature of the two or more first contaminants.

139. The method of any one of claims 129 to 138, wherein the at least one liquid byproduct comprises water and at least one second contaminant.

140. The method of claim 139, wherein the second cold gas is injected into the second insulated space at or below a eutectic temperature of the at least one second contaminant.

141. The method of claim 139, wherein the at least one liquid comprises two or more second contaminants, wherein the cold gas is injected at or below a lowest eutectic temperature of the two or second more contaminants.

142. The method of any one of claims 129 to 141, further comprising a step of heating a portion of the first insulated space.

143. The method of any one of claims 129 to 142, further comprising a step of heating an inner of the second insulated space.

144. The method of any one of claims 129 to 143, wherein the step of mixing the wastewater with the first cold gas comprises flowing the first cold gas in the opposite direction of a flow of the wastewater.

145. The method of any one of claims 129 to 143, wherein the step of mixing the wastewater with the cold gas comprises flowing the cold gas in the same direction of a flow of the wastewater.

146. The method of any one of claims 129 to 145, wherein the step of mixing at least one liquid byproduct with the second cold gas comprises flowing the second cold gas in the at least one liquid byproduct.

147. The method of any one of claims 129 to 146, wherein the step of injecting the second cold gas into the second insulated space comprises sourcing the sourcing the second cold gas from a liquid nitrogen system.
